(19) United States
(12) Patent Application Publication
(10) Pub. No.: US 2010/0139077 A1
(43) Pub. Date: Jun. 10, 2010

(54) Method of Forming A High Friction Joint

(75) Inventor: Geoffrey Robert Linzell, Hatfield (GB)

Correspondence Address: FOX ROTHSCHILD LLP, 997 Lenox Drive, Bldg. #3, Lawrenceville, NJ, 08648, US

(73) Assignee: Ball Burnishing Machine Tools Ltd, Hertfordshire (GB)

(21) Appl. No.: 12/442,892

(22) PCT Filed: Sep. 26, 2007
(86) PCT No.: PCT/GB2007/003668

§ 371 Date: Mar. 25, 2009

(30) Foreign Application Priority Data
Sep. 26, 2006 (GB) 0618873.4

(51) Int. Cl. F16L 37/02

(52) U.S. Cl. 29/525

(57) ABSTRACT

There is provided a method of forming a high friction joint between a first tubular metal body and a second tubular metal body, the method comprising: selecting a first tubular metal body having a first outer face at a first end portion thereof and selecting a second tubular body having a second inner face at a second end portion thereof, the first and second faces being capable of overlap to enable the first and second tmbs to fit together; treating the first outer face of the first tubular metal body and/or the second inner face of the second tubular metal body by introducing a friction enhancing agent to at least part of one or both thereof; inserting the first end portion of the first tubular metal body inside the second end portion of the second tubular metal body such as to form a low friction joint therebetween; and moving the first end portion of the first tubular body relative to the second end portion of the second tubular body to create rubbing at the first and second faces to activate the friction enhancing agent and to thereby form said high friction joint.

The invention relates to a method of cold forming high friction mechanically strong sealed joins between a first tubular metal body and a second tubular metal body. The method is suitable for making joins that may later be cold expanded up to the plastic limit of the joined bodies, the joins are useful in the construction of pipe lines, power generation and process equipment, and expandable casing strings for oil or gas wells.

### BACKGROUND TO THE INVENTION

Conventionally, tubular metal bodies, hereinafter variously refereed to as tmbs, are used in construction and process plant, and are otherwise referred to as tubes or pipes, and are mostly joined by fusion welding, either directly with butt welds, which become difficult in thin wall tube because of the risk of blow holes developing. Bolt together flanges are often welded to the ends of each tube section, the flanges are not expandable.

Oil and gas wells are often drilled with a drill head attached to and driven by a column of tubular steel sections that are mostly threaded and screwed together and known as a drill string. After drilling to a predetermined depth drilling is interrupted and the string is disassembled as it is withdrawn to facilitate the insertion and securing into the bore of a larger tubular steel support casing, whose sections may be permanently joined, often welded or screwed together. This procedure is repeated several times until total depth is reached. The casing diameter is progressively reduced to facilitate passing new sections through the installed sections of casing.

It is known that after drilling a bore an expandable casing can be inserted down the bore over the threaded drill string and as the drill head is withdrawn up through the inserted casing it cold expands the casing to better fit the bore. Furthermore it is known that the drill string itself can be cold expanded and left in the bore to become the casing, in which case the need to disassemble the string is eliminated. These procedures reduce drilling costs and potentially provide means of making a bore with the same diameter casing throughout, such bores are described as a mono-bores. Flow rates of mono-bores are greater than stepped bores but are limited by the amount by which the string of pipes can be mechanically expanded. Thus to maximise the flow rates it is desirable to be able to expand pipe joins up to the plastic limit of the pipes themselves which has hitherto proved difficult.

Forge and fusion welding and processes such as brazing are known and potentially suitable for joining expandable casings or drill strings but suffer from the disadvantage of needing to apply high temperatures to operating areas where discharges of volatile materials can occur. Also fusion welding forms a narrow joining band that concentrates stress and changes local metallurgy. In particular, if weld pools solidify too rapidly after welding hydrogen embritalment may cause sudden catastrophic failure as welds crack in service. Drill strings, especially when drilling curved branches, are subjected to high levels of cyclical loading with risk of fatigue failure.

Threaded connections are known for use in the construction of oil drill strings and are limited in the amount of cold expansion they can safely withstand especially those threaded in thin wall tubes, and which are also expensive to machine especially on large diameter pipes. Generally it is said that their safe expansion limit is about 25% on diameter.

It has been appreciated that alternative connection methods are needed for joining tmbs that can be expanded up to the limit of the tube, which can range up to 40% over the original diameter.

U.S. Pat. No. 7,017,669 teaches a method for joining pipes in which a first smaller diameter tubular is expanded to form mechanical interlocks with an overlapping second larger body.

WO-A-2005/061,852 teaches a method of raising the grip between cold expanded tubes by coating friction interfaces with a plasma spray that bonds hard angular grains of material onto at least one of the overlapping pressed together surfaces in similar overlapping joins. Potentially this method is suitable for making joins between large diameter thin wall pipe that are said to be expandable up to the physical limits of the tube without loss of mechanical integrity or seal. Thus, expandable joins employing interlocking pre shaped bodies or rough hard friction surfaces are known. Such joints exhibit conventional dry friction in which the level of static friction is greater than dynamic friction and if slip occurs, the mechanical strength of these joints falls and the joins are permanently weakened. When expanded these interlocking joins may suffer from similar limitations as encountered when expanding threaded joins because the amplitude of the rolled interlocks reduces with expansion. Also the flame sprayed bonds holding interlocking grits may fracture as the tube surface grows during diametric expansion. Thus there are limitations associated with the use of these interlocking friction joins for joining expandable pipes.

Applicant has now realized that there exists a need for an improved method of making low cost pressure tight friction joints between medium and large diameter thin wall tubular bodies that are safe and easy to make in unfavourable environments. To be fit for purpose in the context of drilling for oil or gas, these joints must have good cyclical fatigue life and be cold expandable to the limits of the joined tubes and desirably if overloaded minor slip can occur without loss of seal to prevent the tube shearing after which joins recover full mechanical strength.

Applicant's earlier patent application EP-A-533,741 describes means for joining tubular bodies with couplings held together by friction, made by either forcing a first interfering circular body inside a matching bore and/or driving high grip slightly tapered wedges between the tubes and an outer ferrule, which joints provide parent metal strength joints. However these methods are not suited to joining large floppy thin-wall tmbs because of the practical difficulties of securely gripping, aligning and inserting without distorting or damaging the tubes. The term ‘floppy’ means prone to elastic distortion due to gravity as commonly experienced in unsupported thin wall tubes, especially horizontally orientated tubes. Therefore, whilst it may be practical to assemble small diameter stiff tubes with interfering fits it is generally impractical to align and press together larger diameter interfering thin wall parts by forcing one inside another. Also other joints described in EP-A-533,741 employ tapered wedges that are not suitable for further cold expansion because they employ low density sintered materials that extrude and distort erratically during cold expansion. Neither do these friction joints have a positive interlock, which Applicant now appreciates to be strictly unnecessary in some applications, but are useful as a snap together loose assembly aid and importantly provides a high integrity metal to metal seal independent of the frictionally coupled interfaces.

The problem therefore now identified is how to mechanically join and seal a series of tmbs (e.g. large diameter, thin-wall metal pipes), in hazardous environments such as those experienced on oil rigs or underwater with joints that are expandable up to the plastic limits of the joined pipe without loss of seal or torsional or tensile strength within the joint.

The solution now provided is the method of forming a high friction joint between a first tubular metal body and a second tubular metal body described herein. In a key step, that method involves treating insertable end portions of those tmbs with a friction enhancing agent. That friction enhancing agent is then activated to form a high friction joint by movement of the first tubular body relative to the second into which it is inserted.

The method herein aims to provide cold formed high strength friction joints between mating overlapping smooth surfaces of the tubular metal bodies being joined, the strength of the frictional coupling therebetween can be made of the same order, and potentially stronger, than the tmbs in shear, tension and torsion, hence the joints will provide parent metal strength. Applicant has appreciated that high levels of friction of the order of four times the levels of conventional metal to metal dry friction may be provided for by introducing the friction enhancing agent between overlapping tmbs. Suitably, overlapping areas of tubular metal body are held with the outer tubular metal body in elastic tension and the inner tubular metal body in elastic compression, which ensures good metal to metal friction contact spread evenly over significant areas. In aspects, the proportions of the joint are made symmetric about the central axis of the two joined bodies and the density of the materials remains constant during expansion and their relative material characteristics (for example strength and elasticity) of the overlapping portions change in close unison with non overlapping portions to avoid irregular extrusion and distortion during subsequent further radial expansion, during which expansion the friction interface expands uniformly about the tube axis with no loss of frictional coupling.

Additionally, a separate expandable seal that is independent of the frictional coupling may be provided within the high friction overlap area in a recess in each matching face of the tubular metal body that when aligned creates a cavity in which a compressible seal locates. Typically, the seal compresses during initial assembly then springs outwards as it locates in the aligned recessed grooves to act as a seal and snap together positive interlock. The compressible seal may be made of dissimilar material so that it is unaffected by the friction enhancing materials. Upon expansion, the joint will expand evenly up to the burst limit of the joined tubular sections.

When used to assemble pipe lines or expandable drill strings or bore-casings, lengths of large diameter thin wall pipes need to be precisely positioned without damaging their surfaces, especially the mating surfaces and those exposed to aggressive chemicals in service, which damage sites can become vulnerable to corrosion later in service. Furthermore, for economic reasons the positioning of the pipes and forming of the joins is desirably done as a continuous process when laying a pipe-line or drilling a deep bore. Therefore the handling and in particular the gripping of the tmbs must be done without indenting or depositing dissimilar metals onto their surfaces and this requires additional apparatus. In the case of drill strings and casing strings used also for drilling, conventionally apparatus such as hangers and drives grip the outside of the tube to provide rotary drive and feed.

Furthermore, in the case of such strings the adding of each new pipe length is done prior to it reaching the hanger/drive apparatus. Therefore additional apparatus is required to make the joint, which additional apparatus may act (grip) on the outside or the inside the tube. If acting on the outside the grip is pressed against the outside of the tube or if acting on the inside the grip is pressed against the inside of the tube to form the frictional coupling.

The additional apparatus is also required to align the tubes one with respect to the other preparatory to insertion and then inserting and forming the join (in relation to the specialised application in oilfields, the term stabbing is frequently used in association with positioning Oil Country Tubular Goods [OCTG], furthermore the term pin and box are often used to describe the male and female tubular members with OCTG.

Generally external gripping apparatus is most convenient on smaller diameter pipes and internal gripping apparatus is most convenient on larger diameter drill strings and especially on very large diameter pipe lines made by the method. Exceptionally thin tubes may be gripping inside and out.

These additional problems are solved by apparatus that grips, aligns and positions the conditioned surface in frictional contact within the overlap and slides the frictionally coupled tubes one against the other to raise the friction coupling by activating a friction enhancing agent placed within the overlap. Joints can be individually pressure tested within the same apparatus.

This apparatus requires a level of grip that is potentially beyond those achievable with conventional grippers without damaging the tube surfaces. This problem is solved by use of gripping elements that employ similar friction enhancing agents as used in the formation of the high friction joints.

### SUMMARY OF THE INVENTION

According to one aspect of the present there is provided a method of forming a high friction joint between a first tubular metal body and a second tubular metal body, the method comprising:
I. selecting a first tubular metal body having a first outer face at a first end portion thereof and selecting a second tubular body having a second inner face at a second end portion thereof, said first and second faces being capable of overlap to enable the first and second tubular metal bodies to fit together;
II. treating the first outer face of the first tubular metal body and/or the second inner face of the second tubular metal body by introducing a friction enhancing agent to at least part of one or both thereof;
III. inserting the first end portion of the first tubular metal body inside the second end portion of the second tubular metal body such as to form a low friction joint therebetween; and
IV. moving the first end portion of the first tubular body relative to the second end portion of the second tubular body to create rubbing at the first and second faces to activate the friction enhancing agent and to thereby form said high friction joint.

### DETAILED DESCRIPTION OF THE INVENTION

There is provided a method of forming a high friction joint between a first tubular metal body and a second tubular metal body. The so-formed joint desirably provides for parent metal strength and is suitable for further expansion after assembly up to the ultimate strength of the weaker tubular metal body without loss of joint strength or seal efficiency. The intention is to provide a joint suitable for transmitting torque, while supporting its own weight when used in a long vertical string (e.g. when used to secure drill parts).

Herein the term ‘high friction joint’ is used to mean a joint that has greater frictional joining capability than the ‘low friction joint’ referred to herein, and in particular to a ‘high friction joint’ that is suitable as an industrial high friction join for the purposes described herein. The frictional characteristics of the low friction joint being typical of dry smooth clean steel surfaces with a coefficient of friction in the range 0.1 to 0.4 whereas a high friction joint will exhibit a coefficient of friction more than double these levels.

In a first step the method involves selecting a first tubular metal body having a first outer face at a first end portion thereof and selecting a second tubular body having a second inner face at a second end portion thereof. The first and second faces of the first and second tubular metal bodies are capable of overlap to enable the first and second tubular metal bodies to fit together.

The first and second faces are typically adjacent to (i.e. close to, but not necessarily at) the respective ends of the first and second tmbs.

In embodiments, the first tubular metal body, the second tubular metal body and/or any tubular metal coupling member are comprised of a ductile metal, preferably steel.

In embodiments, the method involves sizing a clean smooth area at the first end portion on the outside of the first tubular metal body to form a first outer face and sizing a matching clean smooth area on inside at the second end portion of the second tubular metal body to form a second inner face.

In embodiments, the faces of the first and second end portions are both smooth and threadless.

The method involves treating the first outer face of the first tubular metal body and/or the second inner face of the second tubular metal body by introducing a friction enhancing agent to at least part of one or both thereof. Typically, this step is carried out prior to bringing the tmbs together, and may indeed, be carried out remotely (e.g. as a pre-step), or incorporated into a component of the joint for release during assembly. In embodiments, this step involves depositing the friction enhancing agent onto at least part of one or both of the first and/or second faces or by incorporating the friction enhancing agent into at least part of one or both of the first and/or second faces. In other embodiments, the friction enhancing agent may be applied to the tmbs after bringing them together such as by squirting into a gap existing between such brought together tmbs when in loose (e.g. clearance fit). In another embodiment the agent is carried and released from a carrying body (e.g. a seal) that is placed in sliding contact with at least one of the faces to be joined as the joint is assembled.

In embodiments, the faces of the tubular bodies are initially smooth before introducing the friction enhancing agent. Thus, smoothing of these faces might in embodiments, comprise a pre-step that is carried out before introducing the friction enhancing agent.

In embodiments, the faces of the tubular bodies are initially clean and free of dirt and mill scale, corrosion and hydrocarbons before introducing the friction enhancing agent. Thus in embodiments, the treating of these faces to clean and remove dirt and mill scale, corrosion and/or any hydrocarbon contaminants may comprise a pre-step that is carried out before introducing the friction enhancing agent.

The friction enhancing agent is preferably a chemical friction enhancing agent and may be introduced as such or as an active component of a friction enhancing agent that may also contain other components such as one or more cross-linkers, solvents, carriers, pH adjusters and diluents. In embodiments, the chemical friction enhancing agent is without friction enhancing grits in suspension.

In embodiments, the friction enhancing agent is introduced in the form of a low viscosity liquid, a gel, a grease, a liquid that cures to an adhering rubber film as described in the Applicants previous patents U.S. Pat. No. 6,784,244B1 and GB2290299.

In embodiments, a thin film of friction enhancing agent is applied to any of the faces of the tubular bodies by rubbing the face with a mild abrasive pad impregnated with the friction enhancing agent as described in the Applicants previous patents U.S. Pat. No. 5,902,360, GB2322312 and GB2293387.

In embodiments, the friction enhancing agent is a siloxane, preferably a hydrogendimethylsiloxane.

In embodiments, the friction enhancing agent is arranged to release single atoms of hydrogen during and/or after forming of the high friction joint.

In embodiments, the friction enhancing agent is CCl₄.

In embodiments, a substance is added to the friction enhancing agent which substance is detectable with instruments.

Prior to the friction enhancing agent being activated, the method also involves (part or fully) inserting the first end portion of the first tubular metal body inside the second end portion of the second tubular metal body such as to form an initial low friction joint therebetween. The faces within the initial low friction join held pressed together by some material of the inner body being held in elastic compression and some adjacent material of the outer body is held in elastic tension, the pressed together surfaces interact to resist sliding, but not to the extent that a friction enhanced joint is formed therebetween.

In embodiments, the method involves (part or fully) inserting the first end portion of the first tubular metal body inside the second end portion of the second tubular metal body such as to form a loose (e.g. a clearance) fit therebetween. It will be appreciated that such a loose fit is enabled if the outside diameter of the first (prepared) end portion of the first tubular metal body is less than the inside diameter of the second (prepared) end portion of the second tubular metal body.

The method may also involve expanding the first end portion of the first tubular body and/or compressing the second end portion of the second tubular body such as to form the initial low friction joint therebetween. Such expanding/compressing is achieved using a suitable swaging apparatus.

In embodiments, the initial low friction joint is made by part inserting parts with an interference fit, the insertion stopped before any treated surfaces enter the overlap. ‘Interference fit’ means that the diameter of the inner tubular face of a tubular body is slightly larger than the diameter of the outer contacting face so that when inserted (by forcing together) the friction faces are held The interference fit is thus, suitably a relatively light press fit. In aspects, the faces are in dry asperity contact with a uniform micro roughness.

To finally position the initially joined tubes one with respect to the other the method further involves moving (e.g. axially or radially, that is to say rotating) the first end portion of the first tubular body relative to the second end portion of the second tubular body to create rubbing (e.g. slipping) at the first and second faces to activate the friction enhancing agent and to thereby form said high friction joint. The nature of the said high friction joint during forming is typically that as soon as the static friction resistance is overcome and sliding commences the kinetic frictional resistance rises above the previous static level, which is contrary to the behaviour of conventional dry friction joints. In embodiments, the step of rotating involves applying rotational torque up to a predetermined level, in either direction.

In embodiments, the applied movement (e.g. resulting from axial force or rotational torque) is monitored and disconnected when the applied force or torque reaches a predetermined level.

In embodiments, the step of moving (e.g. rotating or sliding) involves applying a forming force (e.g. torque) between the tmbs that (e.g. axially or rotationally) moves the outer face of the first tubular metal body against the inner face of the second tubular metal body to activate the friction enhancing agent to increase the friction coupling of the join in the range 10 to 100% of the torque strength of the weaker of the joined tmbs,

In embodiments, the step of rotating the first end portion of the first tubular metal body relative to the second end portion of the second tubular metal body is by gripping the first tubular metal body and/or the second tubular metal body with one or more gripping elements capable of applying rotational torque.

In embodiments, the or each of said gripping elements comprises a gripping surface. In embodiments, a friction enhancing agent is introduced to said gripping surface. That friction enhancing agent may be any of those previously described and in embodiments may be introduced in any composition or form as previously described.

Modern science teaches that friction caused by chemical interaction between smooth surfaces can be greater than mechanical interlocking. Also according to Coulombs law F≦μN where the gripping force F is proportional to the contact pressure N and is substantially independent of the contact area, thus the gripping surface may be conveniently defined as a relatively small area, for example by a contact line along a roller surface (i.e. the exterior surface of a roller) in mechanical arrangements as described in the Applicants earlier Patent EP-A-1274545 for making self tightening/quick release torque couplings suitable for gripping round shafts in the form of tmbs while forming the high friction joins by the method herein.

In embodiments, the method additionally comprises:
V. forming a first circumferential groove around the first outer face of the first tubular metal body, and a second circumferential groove around the second inner face of the second tubular metal body, the first and second circumferential grooves being positioned so as to mutually align when the ends of the first and second tmbs are fitted together;
VI. applying a compressible sealing element around the first or second circumferential grooves,
   wherein on inserting the first end portion of the first tubular metal body inside the second end portion of the second tubular metal body the first and second circumferential grooves align, and the compressible sealing element at least partly occupies both the first and second circumferential grooves. The compressible sealing ring preferably acts as a snap ring.

In embodiments, the depth of each circumferential groove is less than half the uncompressed height of the compressible seal element.

In embodiments, the compressible sealing element contains an alloy comprising copper and tin and preferably silicon (e.g. silicon bronze).

In embodiments, a second set of grooves are provided adjacent to the first to house a locking ring, the second to house a sealing ring.

In embodiments, after assembling the friction joint by the method herein, the inside diameter of the joint along with adjacent tmbs is expanded by applying a radial force to the inside of the innermost tubular metal body.

In embodiments, the method herein is carried out at ambient temperature (e.g. from −20 to 45° C.) and is thus, referred to as a cold forming method. This contrasts with other joint forming methods that require the input of external heat energy to enable or support the joint-forming process.

In embodiments of the method herein a tubular coupling member (i.e. a ‘third tubular metal body’ of short length) is inserted between the first tubular metal body and the second tubular metal body. A first high friction joint is then formed between the first tubular metal body at one end of the tubular coupling member and a second high friction joint is then formed between the second tubular metal body at the other end of the tubular coupling member. Thus, in essence two friction joints are formed using the method herein to join together the first and second tmbs via the intermediate coupling member. All embodiments and variations of the method as described herein also apply to such embodiments of the method that make use of a tubular coupling member.

In more detail, in one embodiment that makes use of a tubular coupling member there is provided a method of forming a joint between a first tubular metal body and a second tubular metal body, the method comprising:
I. selecting a first tubular metal body having a first outer face at a first end portion thereof and selecting a second tubular body having a second outer face at a second end portion thereof;
II. selecting a tubular metal coupling member having a third inner face at a third end portion of the coupling member and a fourth inner face at a fourth end portion of the coupling member, the third and fourth faces being capable of overlap with the first and second faces of the first and second tmbs to enable the first and second tmbs to fit together with the coupling member;
III. treating the first outer face of the first tubular metal body, and/or the third inner face of the tubular metal coupling body by introducing a friction enhancing agent to at least part of one or both thereof;
IV. treating the second outer face of the second tubular metal body, and/or the fourth inner face of the tubular metal coupling body by introducing a friction enhancing agent to at least part of one or both thereof;
V. inserting the first end portion of the first tubular metal body inside the third end portion of the tubular metal coupling body such as to form a low friction joint therebetween;
VI. inserting the second end portion of the second tubular metal body inside the fourth end portion of the tubular metal coupling body such as to form a low friction joint therebetween;
VII. moving the first end portion of the first tubular body relative to the third end portion of the tubular metal coupling body to create rubbing at the first and third faces to activate the friction enhancing agent and to thereby form a high friction joint therebetween; and
VIII. moving the second end portion of the second tubular body relative to the fourth end portion of the tubular metal coupling body to create rubbing at the second and fourth faces to activate the friction enhancing agent and to thereby form a high friction joint therebetween.

In embodiments, the step of moving the first end portion of the first tubular body relative to the third end portion of the tubular metal coupling body or moving the second end portion of the first tubular body relative to the fourth end portion of the tubular metal coupling body is by relative axial movement thereof.

In embodiments, the step of moving the first end portion of the first tubular body relative to the third end portion of the tubular metal coupling body or moving the second end portion of the first tubular body relative to the fourth end portion of the tubular metal coupling body is by relative radial movement thereof.

In embodiments, step V comprises inserting the first end portion of the first tubular metal body inside the third end portion of the tubular metal coupling body such as to form a loose fit therebetween; and expanding the first end portion of the first tubular body and/or compressing the third end portion of the tubular metal coupling body such as to form said low friction joint.

In embodiments, step V comprises inserting the second end portion of the first tubular metal body inside the fourth end portion of the tubular metal coupling body such as to form a loose fit therebetween; and expanding the second end portion of the first tubular body and/or compressing the fourth end portion of the tubular metal coupling body such as to form said low friction joint.

In embodiments, step V comprises part inserting the first end portion of the first tubular metal body inside the third end portion of the tubular metal coupling body such as to form the low friction joint, and wherein step VI comprises part inserting the second end portion of the first tubular metal body inside the fourth end portion of the tubular metal coupling body such as to form the low friction joint.

Optionally, that method also comprises:
IX. forming a first circumferential groove around the first outer face of the first tubular metal body, a second circumferential groove around the second outer face of the second tubular metal body, a third circumferential groove around the third inner face of the circumference, and a fourth circumferential groove around the fourth inner face of the circumference, the first and third circumferential grooves being positioned so as to mutually align when the first end portion of the first tubular metal body is inserted into the coupling member, the second and fourth circumferential grooves being positioned so as to mutually align when the second end portion of the second tubular metal body is inserted into the coupling member,
X. applying a first compressible sealing element around the first or third circumferential groove;
XI. applying a second compressible sealing element around the second or fourth circumferential groove;
   wherein on inserting the first end portion of the first tubular metal body inside the third end portion of the tubular metal coupling body the first and third circumferential grooves align, and the first compressible sealing element at least partly occupies both the first and third circumferential grooves, and wherein on inserting the second end portion of the second tubular metal body inside the fourth end portion of the tubular metal coupling body the second fourth circumferential grooves align, and the second compressible sealing element at least partly occupies both the second and fourth circumferential grooves.

In a further embodiment of a method that makes use of a tubular coupling member, the method comprises:
I. selecting a first tubular metal body having a first inner face at a first end portion thereof and selecting a second tubular body having a second inner face at a second end portion thereof;
II. selecting a tubular metal coupling member having a third outer face at a third end portion of the coupling member and a fourth outer face at a fourth end portion of the coupling member, the third and fourth faces being capable of overlap with the first and second faces of the first and second tmbs to enable the first and second tmbs to fit together with the coupling member;
III. treating the first inner face of the first tubular metal body, and/or the third outer face of the tubular metal coupling body by introducing a friction enhancing agent to at least part of one or both thereof;
IV. treating the second inner face of the second tubular metal body, and/or the fourth outer face of the tubular metal coupling body by introducing a friction enhancing agent to at least part of one or both thereof;
V. inserting the third end portion of the tubular metal coupling body inside the first end portion of the first tubular metal body such as to form a low friction joint therebetween;
VI. inserting the fourth end portion of the tubular metal coupling body inside the second end portion of the second tubular metal body such as to form a low friction joint therebetween;
VII. moving the first end portion of the first tubular body relative to the third end portion of the tubular metal coupling body to activate the friction enhancing agent and to thereby form a high friction joint therebetween; and
VIII. moving the second end portion of the second tubular body relative to the fourth end portion of the tubular metal coupling body to activate the friction enhancing agent and to thereby form a high friction joint therebetween

In embodiments, the step of moving the first end portion of the first tubular body relative to the third end portion of the tubular metal coupling body or moving the second end portion of the first tubular body relative to the fourth end portion of the tubular metal coupling body is by relative axial movement thereof.

In embodiments, the step of moving the first end portion of the first tubular body relative to the third end portion of the tubular metal coupling body or moving the second end portion of the first tubular body relative to the fourth end portion of the tubular metal coupling body is by relative radial movement thereof.

In embodiments, step V comprises inserting the third end portion of the tubular metal coupling body inside the first end portion of the first tubular metal body such as to form a loose fit therebetween; and expanding the third end portion of the tubular metal coupling body and/or compressing the first end portion of the first tubular body such as to form said low friction joint.

In embodiments, step V comprises inserting the fourth end portion of the tubular metal coupling body inside the second end portion of the first tubular metal body such as to form a loose fit therebetween; and expanding the fourth end portion of the tubular metal coupling body and/or compressing the second end portion of the first tubular body such as to form said low friction joint.

In embodiments, step V comprises part inserting the third end portion of the tubular metal coupling body inside the first end portion of the first tubular metal body such as to form the low friction joint, and wherein step VI comprises part inserting the fourth end portion of the tubular metal coupling body inside the second end portion of the first tubular metal body such as to form the low friction joint.

Optionally, that method additionally comprises:
IX. forming a first circumferential groove around the first inner face of the first tubular metal body, a second circumferential groove around the second inner face of the second tubular metal body, a third circumferential groove around the third outer face of the circumference, and a fourth circumferential groove around the fourth outer face of the circumference, the first and third circumferential grooves being positioned so as to mutually align when the coupling member is inserted into the first end portion of the first tubular metal body, the second and fourth circumferential grooves being positioned so as to mutually align when the coupling member is inserted into the second end portion of the second tubular metal body,
X. applying a first compressible sealing element around the first or third circumferential groove;
XI. applying a second compressible sealing element around the second or fourth circumferential groove;
   wherein on inserting the third end portion of the tubular metal coupling body inside the first end portion of the first tubular metal body the first and third circumferential grooves align, and the first compressible sealing element at least partly occupies both the first and third circumferential grooves, and wherein on inserting the fourth end portion of the tubular metal coupling body inside the second end portion of the second tubular metal body the second and fourth circumferential grooves align, and the second compressible sealing element at least partly occupies both the second and fourth circumferential grooves.

The first to fourth faces are typically adjacent to (i.e. close to, but not necessarily at) the respective ends of the first to fourth tmbs.

According to another aspect of the present invention there is provided a high friction joint between a first tubular metal body and a second tubular metal body obtainable by a method as described herein.

According to a further aspect of the present invention there is provided a tubular metal body having an inner or outer face at an end portion thereof, which inner or outer face has a friction enhancing agent introduced to at least part thereof.

According to a further aspect of the present invention there is provided an apparatus for use in a method as described herein, the apparatus comprising:
I. a first selector for selecting the first tubular metal body and a second selector for selecting the second tubular body;
II. an applicator for introducing a friction enhancing agent to at least part of one or both of the first outer face of the first tubular metal body and/or the second inner face of the second tubular metal body;
III. an inserter for inserting the first end portion of the first tubular metal body inside the second end portion of the second tubular metal body such as to form a low friction joint therebetween; and
IV. a mover for moving the first end portion of the first tubular body relative to the second end portion of the second tubular body to activate the friction enhancing agent and to thereby form said high friction joint.

In embodiments, the apparatus additionally comprises a swager for expanding the first end portion of the first tubular body and/or compressing the second end portion of the second tubular body.

In embodiments, the mover comprises a rotator for rotating the first end portion of the first tubular body relative to the second end portion of the second tubular body.

In embodiments, the mover (e.g. rotator) includes one or more gripping elements for gripping the first tubular body and/or the second tubular body for rotation thereof. In embodiments, the or each gripping element defines a gripping surface arranged for gripping of a tubular metal body, wherein a friction enhancing agent is provided to said gripping surface. In embodiments, the gripping surface is defined by a roller surface. In embodiments, the apparatus comprises plural gripping elements, each in the form of a roller defining a roller surface, wherein said rollers are arranged sequentially to define in combination a roller bearing surface.

In embodiments, the applicator locates remotely from the other parts of the apparatus. Thus, the step of introducing the friction enhancing agent may be conducted at a different (remote) location from the other steps of the method.

In embodiments, the apparatus additionally comprises a pressure tester for testing the pressure sealing capability of the formed high friction joint.

According to a further aspect of the present invention there is provided a gripping element for use in the apparatus as herein described, which defines a gripping surface arranged for gripping of a tubular metal body, wherein a friction enhancing agent is provided to said gripping surface. In embodiments, the gripping surface is defined by a roller surface.

According to a still further aspect of the present invention there is provided a method of forming a high friction joint between an end of a first tubular metal body and an end of a second tubular metal body, the method comprising:
I. forming a first inner face adjacent to the end of the first tubular metal body, and a second outer face on an expanded length adjacent the to the end of the second tubular body, the first and second faces having natural oxide layers thereon and being overlapable to enable the ends of the first and second tmbs to fit together in use;
II. forming a first circumferential groove around the first inner face of the first tubular metal body, and a second circumferential groove around the second outer face of the second tubular metal body, the first and second circumferential grooves being positioned so as to mutually align when the ends of the first and second tmbs are fitted together in use;
III. applying a compressible sealing element around the first or second circumferential grooves;
IV. treating of the first inner face of the first tubular metal body, and/or the second outer face of the second tubular metal body, by depositing a friction enhancing composition onto at least part of one or both of the said layers or incorporating a friction enhancing composition into part of one or both of the said oxide layers;
V. inserting the first inner face of the first tubular metal body inside the second outer face of the second tubular metal body such that the first and second tmbs fit together with frictional contact between the first inner face and the second outer face, and as sliding proceeds the level of sliding friction rises, the first and second circumferential grooves align, and the compressible sealing element occupies both the first and second circumferential grooves.

According to a still further aspect of the present invention there is provided a method of forming a joint between an end of a first tubular metal body and an end of a second tubular metal body, the method comprising:
I. forming a first outer face adjacent to the end of the first tubular metal body, and a second outer face adjacent the to the end of the second tubular body, the first and second faces having natural oxide layers thereon;
II. forming a tubular metal coupling member having a third inner face adjacent one end of the coupling member and a fourth inner face adjacent the other end of the coupling member, the third and fourth faces having oxide layers thereon and being overlapable with the first and second faces of the first and second tmbs to enable the first and second tmbs to fit together with the coupling member in use;
III. forming a first circumferential groove around the first outer face of the first tubular metal body, a second circumferential groove around the second outer face of the second tubular metal body, a third circumferential groove around the third inner face of the circumference, and a fourth circumferential groove around the fourth inner face of the circumference, the first and third circumferential grooves being positioned so as to mutually align when the end of the first tubular metal body is inserted into the coupling member, the second and fourth circumferential grooves being positioned so as to mutually align when the end of the second tubular metal body is inserted into the coupling member,
IV. applying a first compressible sealing element around the first or third circumferential groove;
V. applying a second compressible sealing element around the second or fourth circumferential groove;
VI. treating the first outer face of the first tubular metal body, and/or the third inner face of the tubular metal coupling body, by depositing a friction enhancing composition onto at least part of one or both of the said layers or incorporating a friction enhancing composition into at least part of one or both of the said oxide layers;
VII. treating the second outer face of the second tubular metal body, and/or the fourth inner face of the tubular metal coupling body, by depositing a friction enhancing composition onto at least part of one or both of the said layers or incorporating a friction enhancing composition into at least part of one or both of the said oxide layers;
VIII. inserting the first outer face of the first tubular metal body inside the third inner face of the tubular metal coupling body such that the first tubular metal body fits inside the tubular metal coupling body with frictional contact between the first outer face and the third inner face, the level of friction rising between the two sliding bodies, the first and third circumferential grooves align, and the compressible sealing element occupies both the first and second circumferential grooves.
IX. inserting the second outer face of the second tubular metal body inside the fourth inner face of the tubular metal coupling body such that the second tubular metal body fits inside the tubular metal coupling body with frictional contact between the second outer face and the fourth inner face, the level of friction rising between the two sliding bodies, the second and fourth circumferential grooves align, and the compressible sealing element occupies both the first and second circumferential grooves.

### Further Detailed Description of the Invention

The joined tubular metal bodies are hollow cylinders otherwise described as a tube or pipe and are suitable for carrying a liquid, gas, or finely divided solid; or a hollow shaft for transmitting rotary mechanical motion; or a structural member for bearing or supporting an axially applied load, and a series of tubular metal bodies joined as described herein can be designed to fulfil any or all of these functions in for example, although not limited to, an expandable drill string, a well bore casing or a pipeline.

The method herein, is particularly suitable for joining thin wall tmbs end to end. The term ‘thin wall’ refers to the ratio of the tubular metal body outside diameter to its wall thickness. For the purpose of this description a thin wall body is taken to mean a tubular body with an outer diameter that is at least 4 times greater than its wall thickness giving a ratio of 4:1 and typically in the region of 10:1.

The joints made by the method can be designed to provide mechanical coupling strength up to the mechanical strength of the joined tubular metal bodies. The joints derive their mechanical strength by overlapping lengths of frictionally engaged tube with a friction enhancing chemical agent within the overlap, which upon differential movement (slip) causes the coefficient of friction between the overlapping areas to increase by up to four times by anti-lubricant action. The introduced friction enhancing agent can be made water repellent (hydrophobic) to facilitate making assemblies wet for example under water. It can be made highly viscous like grease to act as a seal and it can be made to cross-link to form a rubber like moulded seal filling any small gaps between the friction faces after assembly.

In embodiments, the method herein includes the steps of:

1. Preparing by sizing for a fit between matching friction faces on the tubular metal bodies to be joined with a loose fit in the diametric range of 0.001% to 10% and more preferably 0.5% to 5% and most preferably 1% to 2%. The friction faces are clean smooth areas adjacent the first end and on the outside of the first body and a matching area on the inside adjacent the second end of the second body, the cleaned areas act as smooth friction coupling faces. The preferred means of preparing the surfaces is to skim off the surface layer and remove mill scale and rust with a cutting tool or by use of shot or sand blasting, mildly abrasive flap wheels or belts, wire brushing, grinding, honing or scraping prior to burnishing and sizing with a rotary roller tool, which burnishing tool raises the bearing area ratio of the cleaned surface to maximise the asperity contact areas. The smoother the faces the greater the number of asperity contacts where cold pressure welding can occur, which maximises anti-lubricant action and even distribution of friction contacts, thus the most favourable conditions for making strong reliable joints is to make the surfaces as smooth and clean as possible. The cleaned surface should be bright clean metal free of corrosion and hydrocarbon oils or greases prior to assembling. The practical figures for roughness will depend upon practical limitations, for example both mill quality DOM tube and welded tube after the weld bead is removed have proved sufficiently smooth after wire brushing and rubbing with medium grade (green or maroon) 3M ScotchBrite brand non-woven abrasive pad. If the tubular metal bodies being joined are gripped and manipulated with currently available gripper die inserts in power tongs as is current practice in pipe line or oil well construction, there is a risk this will cause unacceptably high levels of damage to the tubular metal body surfaces because of the very high levels of grip required to assemble and develop maximum strength within the joints made by the method; sharp teeth may gouge smooth tube surfaces, which damage may limit the safe plastic expansion range of the tube.

Typical available gripper surface technology employs either flame sprayed hard grits or arrays of teeth, both of which derive their grip by indenting the surface. To avoid this industry uses soft dissimilar metal grips made for example with aluminium but in use when these slip they transfer dissimilar metal and these have been known to cause corrosion. A solution is to employ smooth hard steel grips in conjunction with a friction enhancing chemical similar to that used to enhance the friction grip and generally as described in Applicant's co-pending EP-A-1,274,545. A benefit of this is that if slip occurs, the actual level of grip rises to arrest slip. This ability to dynamically arrest slip greatly enhances productivity when the method is used to assemble expandable drill strings because neither the assembly nor drilling process need be stopped to recover grip if slip occurs. After assembly a forming torque may be applied between the assembled gripped body that slides the friction face of the first body against the friction face of the second body to activate the friction enhancing agent and increase the friction coupling of the join in the range 10 to 100% of the torque strength of the weaker tmbs. Suitably, the forming torque is applied with grips whose friction coupling characteristics match or exceeds the friction resistance of the forming join while minimising surface damage on the tmbs.

Providing the tube material has low carbon and a fine grain structure, which minimises work-hardening, the assembled overlapping fully formed friction join made by the method will be able to expand by an approximately similar amount and at a similar rate as the tubes being joined. To facilitate precisely uniform expansion the thickness of the overlap sections must be reduced to provide a wall whose combined thickness across the join are of similar thickness (strength) to the tube walls. However, where the walls of the tubular metal bodies are relatively thin this may not be considered worth the additional difficulty and cost of machining the tube ends to reduce their thickness, which reduction in wall thickness reduces the burst pressure of the tube joint, therefore it is more practical to leave the tube thickness unchanged and provide extra power to force the expansion tool (for example a swage) through the stiffer overlapping joint section during subsequent radial expansion, they still expand at a similar rate.

Normally the assembly is made at ambient temperatures in the range −20 to +45° C., and the joints are unaffected by temperature unless the temperatures are so low as to reduces the ductility of the tubular metal bodies. The friction enhancing agents will function from −30 to 100° C. If it is impractical to swage the parts together, then by warming or cooling one or both parts appropriately an initial loose fit can be made, then after assembly the joint may be torqued up to its specified frictional resistance after the temperatures have equalised.

Tapered ‘lead-ins’ are recommended to facilitate engagement (stabbing) of the tubular parts during assembly. When inserting tubes together it is important to establish good initial alignment. In embodiments, the start of the actual insertion is between dry clean faces that have not been treated with the friction enhancing agent, because if treated they spontaneously form micro welds upon initial contact, which may cock and throw the tubes out of alignment and cause severe distortion and leaky joints as the misaligned tubes are forced together. If the friction between the interfering faces does not rise high enough after insertion and swaging, due to for instance the presence of stray lubricant or dirt, it is raised further by continuing to slip the friction faces to train the friction higher. In the event of a faulty joint forming the faulty section is cut out and the ends of the tubular metal bodies reworked.

Suitably, the tubular metal bodies are swaged or press-fitted together bringing the opposing friction faces into moderate friction contact, thereafter held in contact by opposing elastic deformations due to induced compressive hoop stress within the inner overlapping body and opposing radial tensile hoop stress in the outer overlapping body, the swaging usually done with solid dies or rollers. The resultant moderate contact pressures are adequate to establish enough rubbing contact within an initial low friction join so that during subsequent slipping activates the friction enhancing agent (e.g. by rubbing).

Alternatively, and providing the safety aspects can be managed, high energy discharge means such as electromagnetic forming or high burn rate gas charges or chemicals (explosives) are useful for swaging because the deformation due to these occur at near supersonic speed with much less spring-back and the resultant friction joints are strong and form instantly.

The joint is therefore held together by high static friction at the interface between a first tubular metal body and a second tubular metal body. The high level of friction is the result of many cold pressure asperity welds forming during sliding between the formed faces on the tubular metal bodies after their treatment with a friction enhancing material. As sliding continues welds are progressively formed and broken, material is transferred between faces, welded then sheared and re-welded, which action causes disruption between the formed faces at the sliding interface. At the completion of sliding, the pressed together disrupted faces provide mechanical interlocks between the roughened faces interspersed by cold pressure asperity welds. The shear strength of these interlocked surfaces can be similar to the parent metal.

Within each over-lapping face there may be formed one or more annular grooves that are positionally aligned during assembly, into which aligned grooves is preferably placed a compressible metal seal made with metal chosen or treated to be unaffected by the friction enhancing compound.

Siloxane based friction enhancing agents do not work between copper and its alloys and steel. In embodiments, the preferred metal seal materials are copper bearing alloys or materials that can be plated with a layer of copper, which prevents damage to seals as the joints are assembled. Suitable copper alloys are those employing tin or zinc and are known by the generic names of bronzes and brasses respectively. The preferred bronze for forming seals in the subject joins is wrought silicon bronze which has excellent corrosion resistance and its ultimate tensile strength and % elongation approximately matches those of the low carbon steel used in expandable tubular metal bodies. The preferred brass is an alpha brass. Furthermore silicon bronze and alpha brass seals can be annealed to facilitate ease of assembly and they beneficially work harden rapidly as they are cold worked during the assembly process where they act as cleaning scrappers.

Polymeric materials such as plastics and rubbers can be used for sealing however there are concerns that some such materials when operating under certain conditions are vulnerable to extrusion and attack from hydrocarbons and hydrogen sulphide. In embodiments, a preferred method is to make the seal with a combination of materials, some metallic and some polymeric, the metals chosen to provide mechanical strength and the polymers to form superior large contact area seals. The polymeric material used to coat at least some parts of the metal body of the seal. The preferred friction enhancing chemical is an effective lubricant between most polymers and steel and therefore if the metal seal ring is coated with a hydrocarbon tolerant polymer then it is beneficial to allow the friction enhancing chemical to wet the seal during assembly. Providing the fit between expanded overlapping pipes is good, that means the initial roughness peaks do not exceed 5 micron there will be minimal seal extrusion between expanded pipes and therefore in some cases polymeric seals can be used. However such seals, usually in the form of elastomeric ‘O’ rings are practicable only up to about 1500 psi (pounds pre square inch) whereas the oil industry requires pipe joints to be rated to 5000 psi. In embodiments, providing the seal grooves are well machined metal seal rings close the extrusion gap to small fractions of a micron, sufficient to eliminate extrusion. The preferred method is to coat appropriate contacting faces of the metal seals with a thin film of polymer very good seals are provided that are effective at 5000 psi.

In embodiment, the preferred polymeric seal materials are perfluoroelastomers because they are the most chemically resistant of all elastomers and will resist hydrogen sulphide at temperatures of the order of 200° C. on the one hand and sub-zero artic conditions on the other. ‘O’ rings made with these materials may be incorporated into the seal grooves either singly or preferably in combination with a metal, for example a steel, silicon bronze or alpha brass compressible seal ring. In embodiment, the elastomeric seal material is PTFE modified fluorosilicone that is substantially unaffected by low molecular weight siloxane based friction enhancement chemicals and indeed are useful for absorbing friction enhancing agents and releasing them onto the friction surfaces at insertion. Buna-N synthetic rubber with high nitrile content may be used for lower at lower pressures and temperatures. As the nitrile content increases, resistance to petroleum base oils and hydrocarbon fuels increases, but low temperature flexibility decreases.

In embodiment, a preferred shape for a moulded polymeric seal resembles a rectangle with each corner with radius and the sides concaved. Such shaped seals are described as Quad-Rings, a registered trade name of AFM Incorporated, 11530 SW Tiedeman Avenue Tigard, Oreg. 97223 USA.

The cross-section shape of the sealing ring must allow the ring to compress during assembly and then spring back sufficiently to form a pressure tight seal within the grooves and when the joint is further expanded it must be able to stretch and maintain the seal.

In embodiment if made of sufficiently strong metal the sealing ring also acts as a mechanical interlock bridging across the overlapping faces to further resists tensile loads across the joint. In embodiment, a strong metal seal ring can be shaped to act as a scraper that scrapes dirt and water off the mating friction joining face as the parts are inserted to form the overlap within both press and swage fitted joints. In embodiment, the seal is a metal body with an absorbent member that carries and releases a friction enhancing agent as the tmbs are positioned in overlap during the assembly of a joint.

If the joints are used in a drill string, by which is meant a remote under-ground drill head driven by a column of joined tubular metal bodies, in which case the tubular metal bodies act as a giant spring in torsion, and vibrations emanating from the drill head can initiate resonance within the column of joined tubes. It is likely under conditions of resonance that peak torsional loads might momentarily exceed the elastic limit of the column. Providing some friction enhancing agent remains between the friction faces and if the torsional strength is exceeded during drilling, joins momentarily yield and slip and absorb peaks of energy, then recovering full join strength.

The fatigue behaviour of high friction interference joints made by the method resembles that of shrink fit joints, the theory of which is very adequately covered in the literature. It is believed that because the frictional coupling in the joints is spread over a large area the stress concentrations are much lower than those experienced in threaded or welded joints.

The friction enhancing agent can be any chemical agent that increases sliding friction. In embodiments, the active ingredient is generally a low molecular weight liquid with low viscosity and low film strength that it is unable to maintain separation of the faces either when static or during sliding. Such materials can be highly surface active and can be difficult to prevent from spreading into unwanted areas. Control is exercised by using a carrier medium such as a grease, a gel or an adhering curing rubbery film, all of which reduce the mobility of the active agent. Alternatively a thin film of friction enhancing material is beneficially applied to a face to be joined by rubbing the face with a mild abrasive pad wetted with the composition. A lofty non-woven web of polymeric fibre with abrasive bonded to or incorporated into its fibres is used for this purpose such as ScotchBrite, a registered trade mark of 3M Corporation, generally used as described in our U.S. Pat. No. 5,902,360. If the abrasive is rubbed sufficiently against a surface, the abrasive action cleans the surface and disrupts some of the natural oxide coating, causing high levels of adsorption of the low molecular weight material as the oxide reforms. After rubbing with the abrasive the surface should be lightly wiped with a paper towel to remove abraded off residues of oxide, leaving the surface bright and clean and virtually dry to the touch.

The coating of a low viscosity fluid of friction enhancing agent is virtually impossible to see with the naked eye, therefore it is difficult to inspect to ensure the coating has been applied. This is overcome by adding fluorescing dye, for example an ultra violet dye, to the friction enhancing agent sufficient to act as a tell tale when illuminated with a black light (ultra violet light). By way of example, a suitable dye that can also be seen with the naked eye is Key Plast Brilliant Yellow, known also as solvent yellow 43 with a CI No. 561930 available from Keystone Aniline Corp. 2501 W. Fulton Street, Chicago, Ill. 60612 USA. By such means each assembled joint can be monitored with an instrument, such as a spectrograph or video camera and the position and thickness of coverage is recorded.

There are several materials suitable for enhancing friction including, but not limited to, highly refined paraffin, carbon tetrachloride and certain siloxanes, all these exhibit very low film strength and are therefore ineffective at maintaining hydrodynamic separation between sliding surfaces. The preferred friction enhancing agent for use in the method herein, is hydrogendimethylsiloxane because it carries hydrogen side groups. It is believed that some hydrogen atoms are sheared off when subjected to shear stress during sliding, thus it has the ability to release single atoms of hydrogen directly onto a surface. On a clean metal, unstable single hydrogen atoms are said to momentarily adsorb and lower the yield point of the outer molecular layers of the sliding faces and thereby enhance plastic flow and asperity welding and friction. When sliding stops the single atoms of hydrogen diffuses out and the metal matrix recovers its normal strength. There has been no evidence that the single atoms of hydrogen released during sliding cause hydrogen embritalment. Hydrogen embritalment is said to be caused by the accumulation of hydrogen molecules at lattice defects and grain boundaries, especially in rapidly cooled weld pools. A hydrogen molecule is H₂ is unable to diffuse across grain boundaries, whereas the much smaller single atoms H can. The release of hydrogen appears to aid the friction enhancement process but does not appear to be the only mechanism for increasing friction because carbon tetrachloride does not release hydrogen!

The types of metals that may be joined by the method includes, but is not limited to mild steel, tool steel, nickel and nickel alloys, chromium iron alloys, stainless steels both ferritic and austenitic and duel phase; aluminium and aluminium alloys; cobalt and combinations thereof. The preferred materials to be joined with the friction enhancing agent are ductile steel, most preferably ductile alloy steel. The method is useful for joining tubular metal bodies of dissimilar metals, providing the coefficient of thermal expansion of the metals are similar or if these differ, the joint does not see a sufficient differential expansion to reduce the contact pressure across friction faces.

Siloxane based compositions are generally hydrophobic and act as strong a water repellents. The active hydrogendimethylesiloxanes tend to weakly cross link over time if catalysed by water, but retains an ability to enhance friction, therefore the occurrence of rust between the joints is only likely on joints with gaps, hence in joints made by the method of the present invention rust corrosion is extremely unlikely to occur unless water is entrapped during assembly. It is recommended that a silicone grease is packed into seal grooves to prevent the entrapment of water and/or oxygen, especially if joints are formed underwater.

### BRIEF DESCRIPTION OF THE DRAWINGS

An exemplary method herein is now described in more detail with reference to the following drawings:

FIG. 1: shown in partial cross-section view are the components for making a high friction joint between a first and second tubular metal body.

FIG. 2: shown in partial cross-section view is a joint assembled with the components shown in FIG. 1.

FIG. 3: shown in partial cross-section view are the components for making a back to back high friction joint similar to that in FIG. 2, between a first and second tubular metal body with an external coupling tube therebetween.

FIG. 4: shown in partial cross-section view is a joint assembled with the components shown in FIG. 3.

FIG. 5: shown in partial cross-section view are the components for making a back to back high friction joint similar to that in FIG. 2 between a first and second tubular metal body with an internal coupling tube.

FIG. 6: shown in partial cross-section view is a joint assembled with the components shown in FIG. 5.

FIG. 7: shown a cross section view is a typical compressible sealing element that is suitable for use in the previously illustrated joints.

FIG. 8: shown is a schematic diagram illustrating an internal apparatus for joining large diameter tubular metal bodies by the method.

FIG. 9: shown is a schematic diagram illustrating an external apparatus for joining medium and small diameter tubular metal bodies by the method.

FIG. 10: shown in partial cross-section view are the components for making a high friction joint similar to that shown in FIG. 2 wherein the parts are sized to interfere and the initial friction joint is made by forcing the interfering parts partway together.

FIG. 11: shown in partial cross-section view is a joint assembled with the components shown in FIG. 10.

FIG. 12: shown in partial cross-section view are the components for making a back to back high friction joints between a first and second tubular metal body using an external coupling section sized to interfere with the tubes.

FIG. 13: shown in partial cross-section view is a joint assembled with the components shown in FIG. 12.

FIG. 14: shown in partial cross-section view are the components for making a back to back high friction joints between a first and second tubular metal body using an internal coupling section sized to interfere with the tubes.

FIG. 15: shown in partial cross-section view is a joint assembled with the components shown in FIG. 14.

### DETAILED DESCRIPTION OF THE DRAWINGS

Referring now to the drawings;

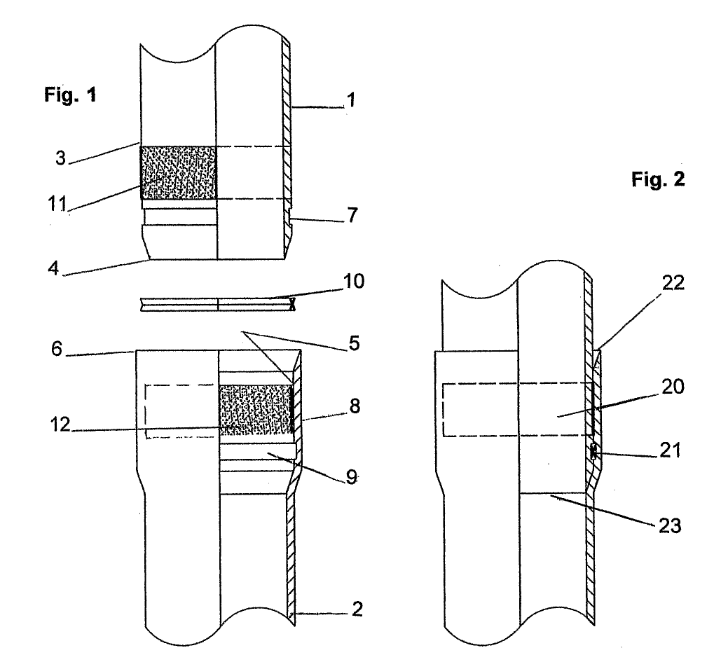

FIG. 1: shows in partial cross-section view the components for making an expandable high friction joint between an end of a first tubular metal body (tmb) 1 and an end of a second tmb body 2. This configuration being a male-tubular metal body/female-tubular metal body parallel overlap swage fit joint.

The method includes the following steps:

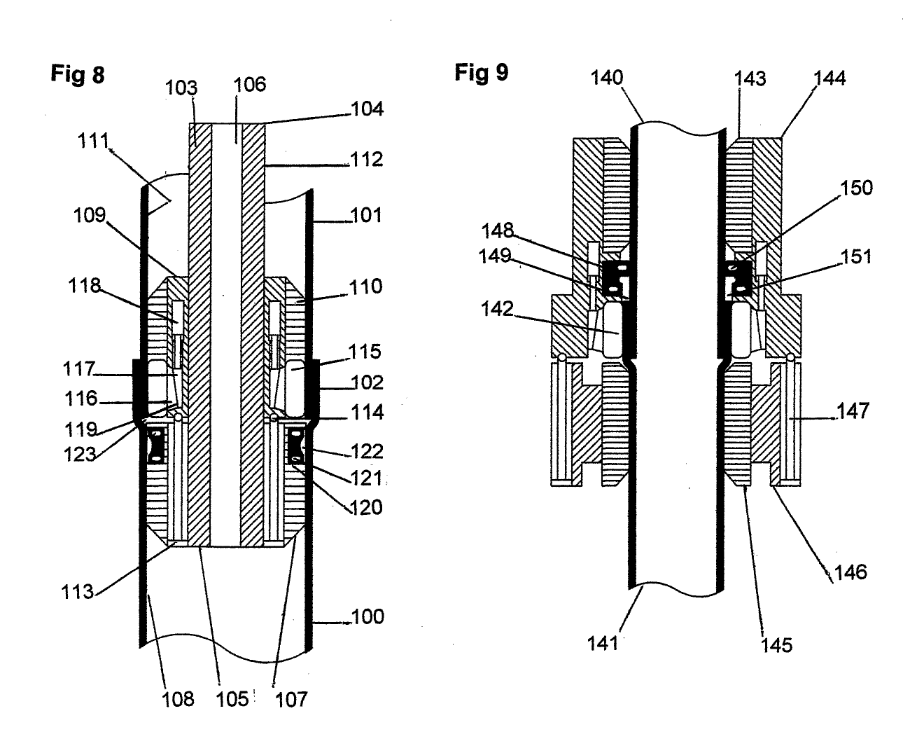

A. Preparing area 3 on the outside of tubular metal body 1 towards its end 4 by sizing and cleaning the surface of corrosion, mill scale and dirt to leave the smooth surface dry, clean and shiny and free of hydrocarbon residues. Area 3 is now referred to as the ‘first outer face’ 3 of the joint. The diameter of tubular metal body 2 is expanded 8 and a second area 5 is prepared on the inner surface at a second end portion adjacent to the end 6 of the second tubular metal body 2. Area 5 prepared similar to area 3 leaving it smooth and clean. Area 3 sized to slide inside area 5 with relative ease.
B. Forming a first circumferential groove 7 around the first outer face 3 of the first tubular metal body 1, and a second circumferential groove 9 around the second inner face 5 of the second tubular metal body 2, the first circumferential groove 7 and second circumferential groove 9 being positioned so as to mutually align when the ends of the first and second tubular metal bodies are fitted together in use. The depth of circumferential grooves 7 and 9 being less than half the uncompressed height of the seal 10.
C. Fitting/applying a compressible sealing element 10 either in the first groove 7 or alternately in the second groove 9, groove 7 being preferred because it is visible and easier to fit.
D. Applying to the first outer face 3 of the first tubular metal body 1 a band of friction enhancing agent of indicated by shaded area 11, that is shown above groove 7, thereby preventing the friction enhancing agent from reaching the groove 7 or the seal 10 during assembly; and/or alternately, if the seal 10 has been previously positioned in groove 9, on the second inner face 5 of the second tubular metal body 2, a band of friction enhancing agent shown by shaded area 12 placed above the groove 9 on face 5. The bands 11 and 12 are positioned to cover only part of the overlap areas 3 and 5 to allow the initial sliding of the parts to occur between faces in a dry low friction state, thereby to establish true parallel alignment and avoiding premature uneven asperity welding that may lead to cocking, buckling and failed joints. The joint may be assembled vertically as shown in FIGS. 1 and 2 or at any other convenient angle. The joint is assembled by carefully aligning tubular metal body 1 onto the same axis as tubular metal body 2, with the seal 10 either inserted in either groove 7 or groove 9 on respective tubular metal bodies 1 or 2. With the parts orientated vertically as shown in FIG. 1, end 4 on tubular metal body 1 is lowered into end 6 of tubular metal body 2 and positioned so the groves 7 and 9 align whereupon the seal snaps into the opposing groove. As tubular metal body 1 was slid into tubular metal body 2, the areas treated with the friction enhancing agent 11 and 12 were also aligned and if not in contact are now brought into contact by either internally swaging the inner tube 1 within the overlap outwards or swaging the outer tube 2 inwards. The first tubular body 1 is then gripped and rotated relative to the second end second gripped tubular body 2 to slip the low friction join formed by swaging, the slipping cause rubbing between faces 11 and 12, the rubbing activates the friction enhancing agent and thereby forms a high friction joint. An apparatus for gripping, aligning, inserting, swaging and rotating (slipping to develop full torque and tensile strength) is illustrated by way of example in FIGS. 8 and 9 later herein.

FIG. 2: shows in partial cross-section view of a joint assembled from the components shown in FIG. 1. In practice either areas 11 or 12 or both 11 or 12 may be pre-treated before assembly, depending upon smoothness of the surfaces, cleanliness and quality of the swaged fit. It is advisable to conduct separate trials to decide how much treatment is needed beforehand because it will vary especially with surface roughness. The high friction treated band within the joint is shown by the broken line within area 20.

Alternatively the joint is assembled dry (without friction enhancing agent) and then a metered amount of appropriate viscosity friction enhancing agent is deposited into recess 22 after partial or full insertion of tube 1 into the expanded section 8 on tube 2. This is allowed to spread between the tubes and wet the faces. The tubes may then be swaged or pressed together and the tubes 1 and 2 gripped and slid into their final positions as torque applied to develop full joint strength. The seal 21 is shown acting as a mechanical interlock between aligned groves 7 and 9. After a 30% final expansion of the diameter of tubes 1 and 2 it was found that there was a small reduction of diameter at 23 on the edge 4 of tube 1 of typically 2%.

FIG. 3: shows in partial cross-section view a similar set of components for make an expandable joint that differs from FIG. 2 by employing a short length of coupling tube 30 that slides over the ends 34 and 36 of tubular metal bodies 31 and 32 respectively, thereby forming two identical joints arranged back to back within the same coupling. This being a male/female-female/male configuration. The assembly procedure includes the following steps:

A. Preparing a first outer face 33 adjacent to the end 34 of the first tubular metal body 31, and a second outer face 35 adjacent the to the end 36 of the second tubular metal body 32, the first 33 and second 35 faces being smooth, dry and free of contaminants.
B. Forming an optional upset ring 37 on the outside surface tubular metal body 31 positioned beyond the reach of the overlapping coupling tube after assembly and a similar second optional upset ring 38 on the outside surface of tubular metal body 32 again positioned beyond the reach of the overlapping coupling tube after assembly. The purpose of these upset rings is twofold; first they provide means of axially gripping tubular metal bodies 31 and 32 enabling the tubular bodies to be pulled together without distorting the tubular metal bodies 31, 32 as the joint is assembled; and second that during subsequent radial expansion of the joint and tubular metal bodies they axially shorten, whereas the upset rings 37 and 38 flatten out and axially extend to compensate for the aforementioned shortening.
C. Forming a tubular metal coupling member 30 having a third inner face 39 adjacent one end of the coupling member and a fourth inner face 40 adjacent the other end of the coupling member, the third 39 and fourth 40 faces being smooth, dry and free of contaminants and being overlappable with a free fit over the first 33 and second faces 35 of the first tubular metal body 31 and second tubular metal body 32 to enable the first tubular metal body 31 and second tubular metal body 32 to fit together with the coupling member 30.
D. Forming a first circumferential groove 41 around the first outer face 33 of the first tubular metal body 31, a second circumferential groove 42 around the second outer face 35 of the second tubular metal body 32, a third circumferential groove 43 around the third inner face 39 of the circumference, and a fourth circumferential groove 44 around the fourth inner face 40 of the circumference. The first and third circumferential grooves 41 and 43 being positioned so as to mutually align when the end of the first tubular metal body 31 is inserted into the coupling member 30, the circumferential grooves 42 and 44 being positioned so as to mutually align when the end of the second tubular metal body 32 is inserted into the coupling member 30.
E. Applying a first compressible sealing element 45 around either the first 41 or third 43 circumferential grooves.
F. Applying a second compressible sealing element 46 around either the second 42 or fourth 44 circumferential grooves.
G. Treating shaded area 47 on the first outer face 33 of the first tubular metal body 31, and/or the area 48 of third inner face 39 of the tubular metal coupling body 30.
H. Treating shaded area 49 on the second outer face 35 of the second tubular metal body 32, and/or the area 50 of fourth inner face 40 of the tubular metal coupling body 30, by depositing a friction enhancing agent onto or into at least part of one or both areas.
I. Inserting seal ring 45 into either groove 41 or 43.
J. Inserting the first outer face 33 of the first 31 tubular metal body inside the third inner face 39 of the tubular metal coupling body 30 such that the first tubular metal body 31 fits inside tubular metal coupling body 30 with loose fit between the first outer 33 face and the third inner face 39, the first 41 and third 43 circumferential grooves aligning, and the compressible sealing element 45 occupying both the first 41 and second 43 circumferential grooves.
K. Inserting seal ring 46 into either groove 42 or 44.
J. Inserting the second outer face 35 of the second tubular metal body 32 inside the fourth inner face 40 of the tubular metal coupling body 30 such that the second tubular metal body 32 fits loosely inside tubular metal coupling body 30, the second 42 and fourth 44 circumferential grooves align, and the compressible sealing element 46 occupies both the first 42 and second 44 circumferential grooves.
K. The inner surfaces of tubes 31 and 32 are gripped and swaged outwards positioning surface 33 in frictional contact with surface 39 to form an initial friction join and surface 35 in frictional contact with surface 40 to form a second initial friction join. The gripped tubes 31 and 32 are then counter-rotated to cause sliding between the above frictional contacts and the sliding activates the friction enhancing materials in areas 47 and 49 and the frictionally coupled joint strengthens up to a predetermined torque.

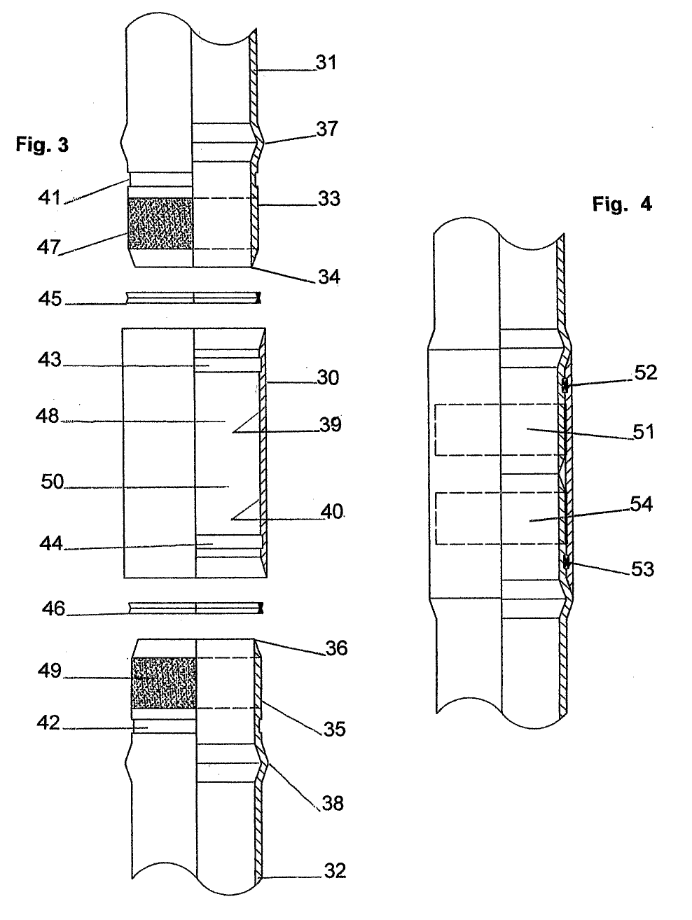

FIG. 4: shows a partial cross-section view of the assembled joint made with the component parts illustrated in FIG. 3. The outline of the trapped high friction contact bands shown with broken lines 51 and 54 towards the centre of the joint. The two seals 45 and 46 are shown at 52 and 53 respectively.

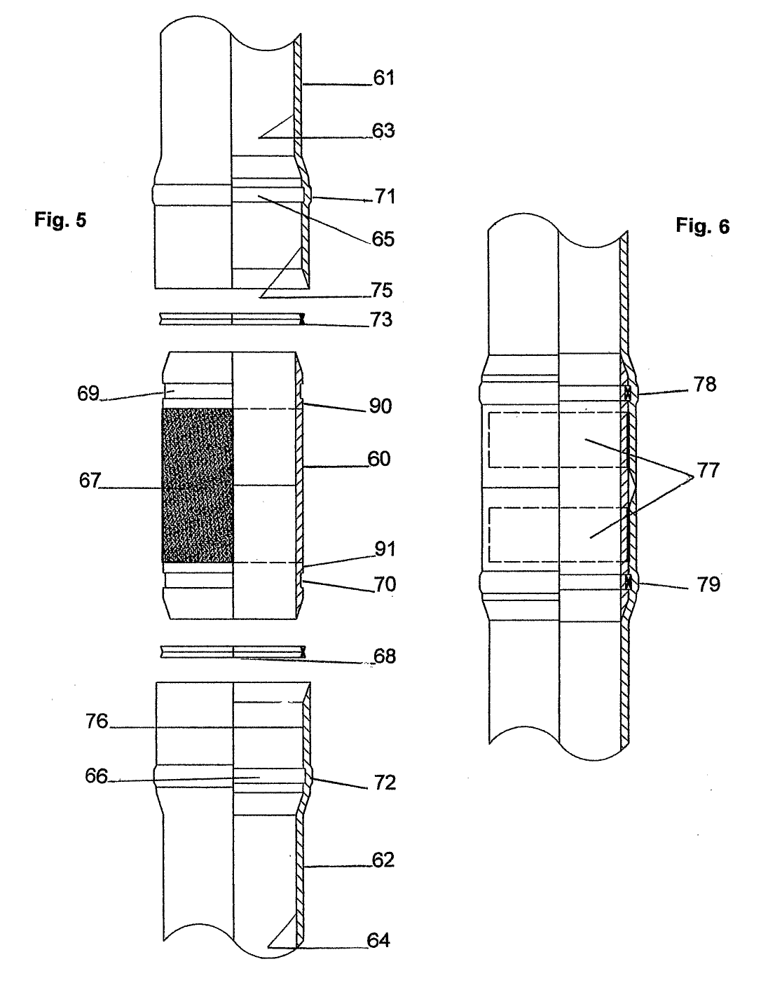

FIG. 5: shows in partial cross-section view of an alternative back to back coupling arrangement that uses two joints made by the method illustrated in FIGS. 1 and 2; it uses a separate coupling tube 60 that fits inside a first tubular metal body 61 and a second tubular metal body 62. This joint differs from that illustrated in FIGS. 3 and 4 by the coupling tube being positioned inside tubular metal body 61 and 62 rather than outside. Thus this joint is configured as a female/male-male/female assembly. In essence the procedural steps for assembling the coupling illustrated in FIGS. 5 and 6 duplicate those for FIGS. 1 and 2 need not be repeated.

An advantage of this configuration is realised when clad, which means internally lined tubular metal bodies are joined. For example, if an alloy steel tube is clad with a corrosion resistant liner at 63 and 64 using for example stainless steel cladding, by using an internal coupling tube 60 made with similar stainless steel the joint is also made corrosion resistant, save for the grooves 65 and 66 that may have been machined through the stainless cladding to house the two seals 68 and 73. The preferred alternative is to form the seal grooves 65 and 66 by cold working (for example cold rolling) over the stainless clad layer that forms the extra projections 71 on the first tubular metal body 61 and 72 in on the second tubular metal body 64, so that the corrosion resistance of first and second tubular metal bodies is preserved intact. Providing the coupling body 60 is made of solid stainless and seals 68 and 73 are also made of a corrosion resistant material such as stainless spring steel, and the entire joint is made corrosion resistant.

The friction enhancing agent is conveniently applied to the outer face of the coupling 60 and shown by the shaded area 67.

FIG. 6: shows in partial cross-section the joint assembled with the alternative construction employing a short male coupling tube. The areas 77 within the broken lines define the high friction areas hidden within the overlap formed between the treated surface 67 on the inner coupling tube 60 and the surface 75 on first tubular metal body 61 and surface 76 on the second tubular metal body 62, where the friction enhancement occurred after swaging and during rotation (sliding/rubbing) of the tmbs 61, 62 with 30.

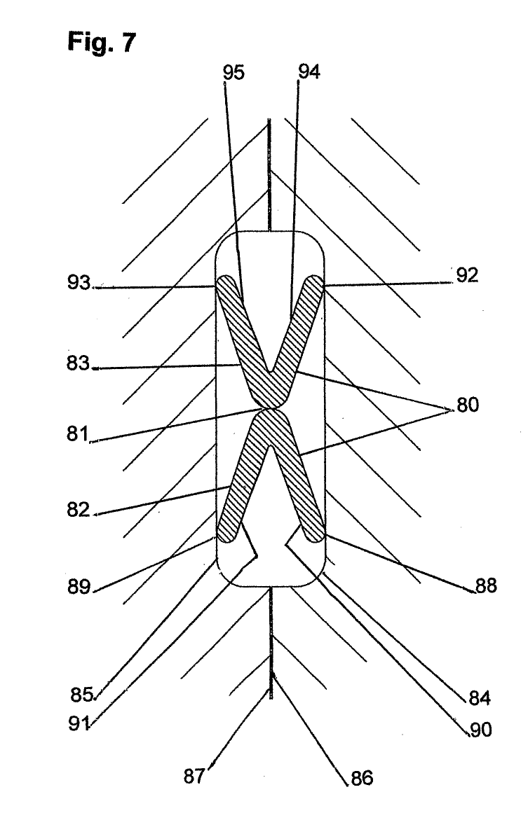

FIG. 7: shows a cross-section view of a metal seal body 80 located in aligned groves 84 and 85 on tmbs 98 and 99 respectively and generally as described in the joints herein. The seal body 80 is formed with a material with elastic/plastic properties that allow expansion with the joined tmbs. The seal body 80 made for example by cold forming and welding or brazing together at 81 two cold rolled strips of metal, shown in this example as ‘v’ sections 82 and 83 arranged back to back and thereby providing a compressible ‘X’ shaped body that nests half in a first groove 84 and half in a second groove 85. The grooves are machined or cold formed in faces 86 and 87 of the joined tmbs. The actual pressure seals formed at the contact between grooves and seal radii at 88, 89, 92 and 93 as the seal body is held trapped and pressed against the steel groove 84 and 85. In the event of a leakage across the friction faces 86 and 87 the seal pressure increases as pressure is exerted on either face 90 and 91 that causes an increase in the radii contact pressure on seal faces 88 and 89 respectively or pressure on faces 94 and 95 causes an increase in the radii contact pressure on seal faces 92 and 93 respectively.

In embodiments, the seal is formed from a single piece of metal without radial weld or braze, which eliminates the risk of the weld/braze 81 fracturing during expansion. In a further embodiment, a parent metal strength butt weld is used to close the ring by welding the cross ‘X’ section 80.

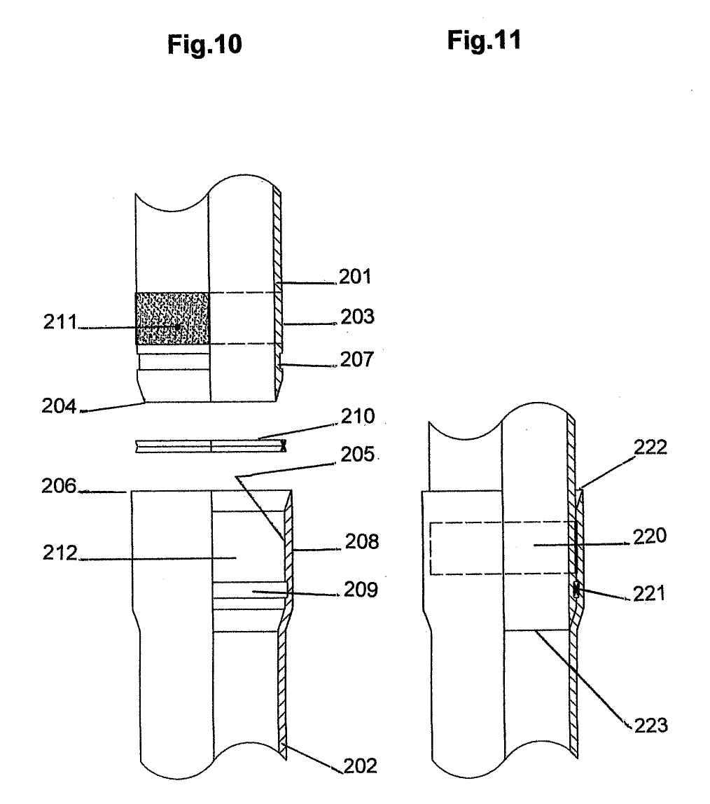

The joints illustrated in FIGS. 1 to 6 and 10 to 15 show practical arrangements for making joints between tubular metal bodies employing separate seals set in aligned grooves, the initial joints in FIGS. 1 to 6 are made by swageing the tubes to bring them into contact and form low friction joints and then causing further sliding within these initial joints to activate friction enhancing agents placed within the joints to raise the frictional coupling with high friction. The joints in FIGS. 10 to 15 are similar but the initial low friction joints are formed by press-fitting parts half way together without friction enhancing agents and form initial low friction joints and then further pressing in with friction enhancing agent to create high friction joints.

The above joints between two tmbs have certain common features; in embodiments, there is provided an overlapping area in which part of the overlapping faces are held in high frictional contact, the contact itself being parallel to the axis of the first and second overlapping tmbs. In embodiment, along some part of the parallel overlap, a friction enhancing agent is applied to overlapping sections that are parallel to the axis of the joined tmbs. In embodiment, at least some parts of the overlapping faces are used for forming pressure tight seals therebetween within the overlap.

The inserts placed in the grooves in the overlap joints shown in FIGS. 1 to 6 and 10 to 15 may vary. In embodiments, a mechanical interlocking ring is positioned between aligned grooves the ring shaped to scrape an untreated friction surface clean as the tmbs are inserted. In a further embodiment, an absorbent ring impregnated with friction enhancing agent is placed within a groove and upon insertion of the tmbs one inside the other the impregnated ring rubs against a clean smooth surface of the mating tmb and applies friction enhancing agent thereto. Referring to FIG. 1 and the ring seal 10, in embodiments, the ring seal when placed in groove 7 may have attached thereto a ring of absorbent material impregnated with friction enhancing fluid positioned behind it distant from end 4, optionally attached to the trailing edge of the ring seal so that upon insertion the leading edge of the ring seal acts as a scraper to clean the surface 5 and the impregnated material at the trailing edge dispenses a thin film of friction enhancing agent onto the scraped clean surface 5. In further embodiments, although not shown, polymeric ‘O’ rings may be incorporated within the seal in groves 7, 9, 41, 42, 43, 44, 65, 66, 69, 70, 207, 209, 241, 242, 243, 244, 256, 266, 269, 270. In a still further embodiment polymeric materials may be bonded onto some or all faces of the metal seals.

In embodiments, the functions of sealing, scraping, dispensing of friction enhancing agent and interlocking may be incorporated in some combination in the same device and located within the same groove. In a further embodiment, some or all the functions of sealing, scraping, dispensing of friction enhancing agent and interlocking are provided with a multiplicity of devices, at least some of which are located in the same aligned grooves. In a further embodiment, some or all the devices providing the functions of sealing, scraping, dispensing of friction enhancing agent are provided in a multiplicity of aligned grooves. In a further embodiment, the functions of sealing, scraping, dispensing of friction enhancing agent and interlocking are provided by devices housed in a multiplicity of grooves at least one of which grooves is not aligned with a matching groove in the opposing joined face.

In any of the joints shown in FIGS. 1 to 6 and 10 to 15 the seal may only require to be nested in a single groove providing the surface on the opposing body that the seal bears against is smooth and remains undamaged by the action of the friction enhancing agent during assembly. In embodiments it is a preferred feature to vary the groove positions and the shape of the grooves to suit different shape seals.

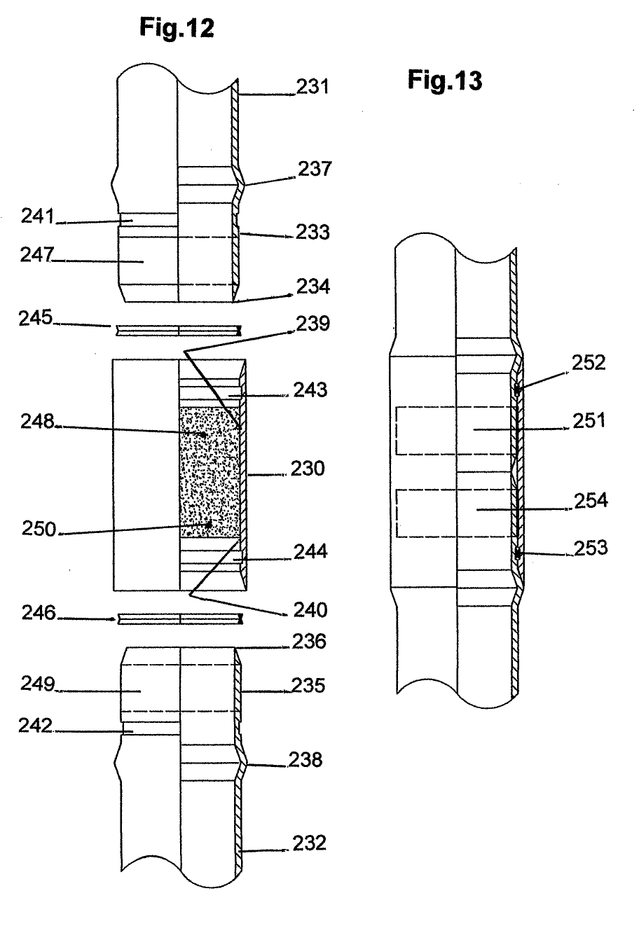

By varying the position of the seals within the overlapping joints other functions are provided. For example with reference to FIG. 1 where the seal groove 7 is positioned towards end 4 as shown, if only area 11 is treated with the friction enhancing agent and seal 10 is placed in either groove 7 or grove 9, tmb 1 can be inserted into tmb 2 without the seal 10 touching the area 11 treated with friction enhancing agent, whereas in FIG. 12 the seal groove 41 is placed inboard of the friction face 47 and this is not practical. Also referring back to FIG. 1, if the seal 10 is resiliently compressible and is a tight fit once pre assembled into groove 7, with roughly half its height standing proud of the groove so that it rubs against and scrapes face 5 as tmb 1 is inserted into tmb 2 even when the inserted tmb is a clearance fit, whereas if the seal is preassembled into groove 9 no scraping occurs upon insertion.

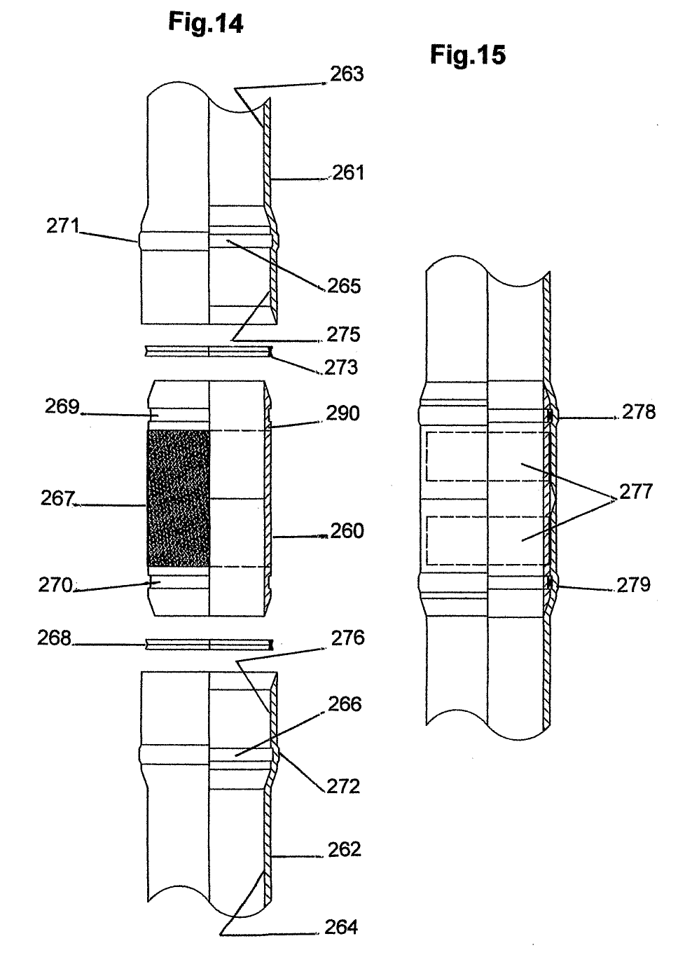

An alternative to the earlier described approach to forming pressure tight seals with sealing elements (ring seals located in grooves), is to use very close fitting parallel smooth metal faces pressed together. This is practical since it has already been shown that joints can be assembled without exposing all the overlapping parallel faces to the friction enhancing agent. For effective face to face sealing some part of the overlaps, such as the areas hitherto used for positioning the grooves 7, 9, 41, 42, 43, 44, 65, 66, 69, 70, 207, 209, 241, 242, 243, 244, 256, 266, 269, 270 may be left as smooth clean sealing faces that are not affected by the action of the friction enhancing agent during assembly. Thus in the joints described herein and illustrated in FIGS. 1 to 6 and 10 to 15, it may under some operating conditions be advantageous to dispense with the grooves 7, 9, 41, 42, 43, 44, 65, 66, 69, 70, 207, 209, 241, 242, 243, 244, 256, 266, 269, 270 and seals 10, 45, 46 68, 73, 210, 245, 246, 268, 273 and instead rely upon face to face seals formed directly between two opposing areas on surfaces 3 and 5 in FIG. 1; 33 and 39, 35 and 40 in FIG. 3; and 75 and 90, 76 and 91 in FIG. 5; and 203 and 205 in FIG. 10; and 233 and 239, 235 and 240 in FIG. 12; and 275 and 290, 276 and 291 in FIG. 14. In embodiments, face to face seals are formed between parallel smooth areas on adjacent parallel faces held in firm contact and removed from areas of high friction contact within same overlapping joints between tmbs. The actual face to face seals positioned in approximately the same locations as the grooves within the parallel overlap regions between close-fitting opposing faces as illustrated in FIGS. 1 to 6 and 10 to 15 herein.

At least one of each seal faces in each seal may be pre-lubricated to prevent galling upon assembly. A seal face may be lubricated, for example by applying a very thin adhering layer carrying a sacrificial lubricant such as molybdenum disulphide or graphite that is pre-applied and allowed to dry or cured on before assembly into a joint to prevent it migrating and affecting the adjacent surface treated with the friction enhancing agent. In embodiments, a face to face parallel seal is formed within a parallel overlap regions between smooth close-fitting opposing faces on tubular metal bodies, in which at least one face is pre-lubricated, the seal faces positioned to prevent them from contacting the friction enhancing agent before or during assembly.

In a yet further embodiment the friction enhancing agent is formulated to cross link into a rubbery mass, any remnants of which left trapped between the micro-roughness of the overlapping surfaces forms a seal therebetween.

In a further embodiment a single or matching pair of grooves can be filled with a composition that acts both as a friction enhancing agent that after forming the joint cross links forming a rubber seal between tmbs.

By way of examples FIGS. 8 and 9 illustrate with schematic diagrams the principles employed within an apparatus for joining tmbs by the method of the invention. Depending upon the diameters of the tubular metal bodies being joined it may be convenient when automating the assembly of the joints to manipulate the tubular metal bodies being joined by the method by gripping either internally as shown in FIG. 8 or externally, as shown in FIG. 9. In embodiments, tubes are gripped either externally or internally or both externally and internally to maximise grip while minimising distortion.

FIG. 8: is a schematic diagram illustrating in a cross-section view of an apparatus that acts only on internal surfaces. Internal acting apparatus are most suitable for joining larger diameter tubes, for example, but not limited to tubes over 250 mm internal diameter because the internal apparatus required to grip and manipulate the tubular metal bodies becomes more difficult to accommodate within the confines of small diameter tubes. Such internal apparatus is designed to propel itself along the tube and is suited to joining large diameter tubular metal bodies orientated either horizontally for pipe-line construction or vertically for joining casing sections in bores.

More specifically FIG. 8 shows a vertically orientated male tubular metal body 101 inserted (stabbed) into an expanded (box) section on a vertically orientated female tubular metal body 100 thereby forming a join within an overlapping section 102.

Before insertion the tube ends are cleaned, tapered and pre-sized to provide a loose fit of the order of between 1 and 3% of diameter to facilitate easy insertion. Whilst cleaning and pre-sizing can be done in situ it may be more conveniently done remotely and the ends of the tubular metal bodies should preferably be protected with removable covers or by applying a removable protective coating. Provision is made for at least one of the mating friction surfaces on either 100 or 101 to have a friction enhancing chemical agent applied thereto before or during assembly. When working in unfavourable conditions or there is a risk of corrosion, it is most preferable that both surfaces are treated with water repellent grease or a curable rubber like composition with friction enhancing properties; or the natural oxides are treated to absorb high levels of the friction enhancing molecules making the friction face surfaces resistant to rust. Alternatively although not shown the apparatus may include means of preparing (by cleaning and sizing) the friction faces and applying the friction enhancing chemical agent. Alternatively the friction enhancing chemical agent may be applied immediately before insertion or if there is a clearance gap after insertion by injection into the clearance gap; or the friction enhancing agent may be incorporated into a seal (not shown) for release during insertion of 101 into 100.

The apparatus shown schematically in cross section comprises a shaft 103 with a first end 104 and a second end 105, this shaft is hollow 106 to provide access for services and ventilation. The shaft 103 has secured towards its second end 105 a radially expandable gripper 107 that expands outwards to grip the tubular metal body inner surface 108. A sliding body 109 slides on shaft 103. The sliding body 109 carries a second radially expanding grip 110 that grips the inner surface 111 of 101 and is driven and turns against the shaft face 112 (drive not shown) and therefore rotates tube 101 against tube 100 clamped with 107 causing rubbing (sliding) within the over lap 102. The sliding body 109 is slidably coupled to the central shaft 103 by hydraulic rams 113 coupled at point 114. By sequentially operating the grips 110 and 107 in association with sliding body 109 along the central shaft 103, the apparatus can be moved axially moved and positioned within the tubes.

The sliding body 109 also carries a series of radially positioned expansion rollers 115. The rollers are disposed about the axis of the joined tubes and retained in a cage similar to those used in roller bearings (not shown) and the cage is driven to rotate radially around the sliding body 109. As individual rollers 115 rotate they present a rolling contact against the inner surface 111 of tube 101. Each roller is supported on a wedge shape cradle 116 that is in sliding contact with a mating wedge 117, the mating wedge 117 is coupled to a driving device, shown here as a hydraulic cylinder 118. Upon operating the cylinder 118 the mating wedge forces the cradle and roller outwards at 119 and the rollers expand the tube 101 as the cage of rollers is driven round, tube 101 is clamped by clamp 110 to prevent rotation. The actual number of rollers can range from 3 upwards.

The solid body 120 is a shaped annular ring and acts as a seal tester. It is made with elastomeric material and is positioned adjacent the grip face of grip 107. When grip 107 is re-positioned so body 120 bridges the join cavity 123 between tubes 100 and 101 and the two inner channels 121 are pressurised to expand the body 120 and create a seal bridging the cavity 123 between faces 108 and 111 with the elastomer body; air in the region of the join cavity 123 bounded by the elastomer body 122 is evacuated and monitored for leaks.

The actual steps combined with the sequence of operation of the schematic apparatus shown in FIG. 8, which facilitates making an assembly of tubular metal bodies by the method of the invention are as follows:
I. preparing the ends of each tubular metal body 100 and 101 by cleaning and sizing and optionally treating with a friction enhancing anti-lubricant chemical agent
II. feeding the tubular metal bodies 100 and 101 from a storage device one at a time and orienting them into an assembly position, ready for assembly,
III. optionally applying or checking that the friction enhancing agent has been applied to the correct areas and in the correct amount,
IV. positioning the assembly apparatus with internal grip 107 inside the tube 100 and with rams 113 extended grip 110 is projected upwards ready to engage with tubular metal body 101. Tubular metal body 101 is lowered over grip 110 and is clamped (gripped). Optionally the friction enhancing agent may be applied or its presence confirmed with at UV test lamp (not shown) before retracting rams 113 to lower tube 100 into the expanded end of tube 100 to form overlap 102.
V. With grip 110 gripping tubular metal body 101 and grip 107 gripping tubular metal body 100, the rollers 115 are positioned inside the overlap 102, the rollers are now driven outwards (expanded) by extending rams 118 by forcing the wedges 117 forward and sliding against cradle supports 116. The roller cage (not shown) is now rotated a roll the rollers around the inside surface 111 of 101 and expand 101 into contact with 100 in the overlap 102 such that an interference fit is created between the tmbs 100, 101.
VI. Tubular metal body 101 is plastically expanded to a point where 100 is approaching its elastic limit, so that after elastic recovery the faces remain in frictional contact after the rolling is stopped and the rollers are retracted, leaving tubular metal body 100 frictionally coupled to tubular metal body 101 within the overlap 102 and with a friction enhancing chemical trapped therebetween, this friction join being the initial low friction join.
VII. Tubular metal body 101 gripped by grip 110 is now rotated about sliding body 109 while tubular metal body 100 is held gripped by grip 107. The torque applied by driven grip 110 causes slippage between the overlapping friction faces within the overlap 102. The slip activates the friction enhancing chemical between the sliding faces and friction rapidly builds such that the required high friction joint is formed. The torque is removed at some predetermined loading or as the friction resistance approaches the shear strength of the weaker tubular metal body 100 or 101.
VIII. With the grips 110 and 107 still operated, rams 113 can be activated to apply a tensile test to the formed join.
IX. The elastomer ring 120 is now positioned over gap 123 by manipulation of grips 110 and 107 in association with rams 113 and cavities 121 within the elastomer body are pressurised to seal the elastomer ring against the inside of the joined tubes 100 and 101 bridging gap 123 and a partial vacuum is drawn to test for leaks between the overlapping tubular metal bodies at 122. Thus the formed joins can be monitored for tensile and torsion and seal quality.

The advantage of automating the assembly procedure is that pipelines for example can be assembled remotely, even potentially under water by pre-applying a curing composition that carries and release the surface active element of the friction enhancing agent that is itself water repellent. A curable rubbery composition is applied and fully cured onto the appropriate surfaces of each tubular metal body before the tubes are immersed in water. During assembly the cured-on material is sheared off the surface as interfering tubes are forced together, thus ensuring that water does not displace the active elements. Seal grooves should be packed with water repellent grease.

In the above example the joints are expanded by applying a radial force with rollers to the inside of the assembled tubes and joints. Alternatively this radial force may be applied by forcing a larger mandrel body through or applying hydraulic pressure to the inner tube surfaces. There is a strong likelihood that the swage if made of steel will tend to gall if it encounters the friction enhancing agent, therefore the swage tool should be lubricated. The conditions of operation of the swage are extreme, and the contact pressure is such that hydrodynamic lubrication is not practical. The alternative is to use extreme pressure or solid or sacrificial lubricants, or most preferably to use a dissimilar material that is not affected by the friction enhancing agents. Typical of these are copper bearing alloys and may be a bronze, a brass or beryllium copper. A technology for the construction and use of self lubricating swages is disclosed in U.S. Pat. No. 6,691,777. A further means of expanding the bore that avoids sliding that might potentially result in galling is described in US-A-2006/0191691 that discloses a stepping expander, wherein the expansion element slides in a lubricated inner chamber and the expansion force is transmitted through a flexible skin. The lubrication requirements are less severe for roller sets as shown in FIGS. 8 and 9. In the case of hydraulic expansion no lubrication is required.

FIG. 9: is a schematic diagram of an apparatus shown in cross section, the apparatus suitable for joining smaller diameter tubular metal bodies, typically up to 250 mm outside diameter, where it is impractical to accommodate the mechanism needed to grip, align and apply assembly forces within the tube. The principle and sequence of the operation is similar to the apparatus described in FIG. 8 and therefore this will be described with reference to the former.

Tubular metal body 140 has the exterior of its first end cleaned and sized and treated with a friction enhancing chemical agent prior to insertion into the prepared, cleaned and sized end of tubular metal body 141, forming an over lap 142 where it is to be frictionally coupled and joined.

The cross section schematic diagram of the apparatus shows a lower radial grip 145 acting inwards to grip tubular metal body 141 on its external surface, the grip 145 slides inwards and outwards on support body 146. When fully expanded outwards grip 145 can pass over the expanded section of the overlap 142.

Tubular metal body 140 is gripped by grips 143. Grips 143 have a rotational drive (not shown) that drives against outer body 144. Also body 146 carrying lower grip 145 is coupled to upper body 144 carrying grip 143. 144 is coupled to 146 by hydraulic rams 147, which hydraulic rams 147 enables tube 140 to be inserted into tube 141. The roller expander 142 operates in a similar way to FIG. 8 except that it contracts and swages the outer tube 141 down onto the inner tube 140 to form the initial friction joint by bringing 141 into firm friction contact with 140. A torque is applied between grips 143 and 145 to slip the joint and develop high levels of friction by activating a friction enhancing agent trapped between the tubular metal bodies 140 and 141. The gripped tubes are also subject to tensile test as before with rams 147.

An elastomeric seal body 148 is shaped to closely fit the step 149 at the end of the overlap due to end of tubular metal body 141. Following insertion, expansion, application of forming torque and tensile testing the apparatus is repositioned to locate the pressure test elastomer body 148 over the end of tubular metal body 141 at 149. The inner pathways 150 within elastomer body 148 are pressurised to expand the elastomer body, forcing it against and sealing it against the outside of the joined tmbs 140 and 141 and a partial vacuum is applied in the inner space 151 of the elastomer body to test the joint for leaks.

Although not shown in a separate diagram, it will be appreciated that if for any reason the gripper action provided by the previously described apparatus proves inadequate, for example if the wall is unable to support the pressure needed to provide the required grip and deforms significantly when gripped with the apparatus described with reference to FIGS. 8 and 9, then gripping is improved by adding support to the tube. This is conveniently done with a third apparatus that simultaneously grips adjacent inside and outside faces of the same tube and is provided by combining the gripping mechanisms shown in FIGS. 8 and 9. In embodiments, an apparatus is provided for forming frictional couplings between tmbs, the apparatus employing internal and external opposing grips for simultaneously gripping adjacent internal and external surfaces areas of the tmbs being frictionally joined. This allows higher contact pressures to be employed without risk of deforming the thin wall body and thereby provides superior grip. When both internal and external grips are used the associated swaging can be applied either internally or externally.

A further method and joints are provided for making expandable mechanical joints between frictionally coupled parallel overlapping tmbs in which the parts are pre-sized to provide an initial tight fitting joint as the tubes ends are inserted one into the other. A low friction joints is formed first by pressing dry clean (and in some cases pre-lubricated) interfering parts together to form the initial friction join by typically inserting the tmbs about half distance into the overlap. One or both of the exposed areas on the over lapping tubes are then treated with a friction enhancing agent and the tubes are then pushed fully together, as the treated surfaces engage with mating faces so the friction rises towards the higher level as the friction enhancing agent is activated by rubbing. After full insertion the joined tubes are gripped and a torque is applied across the joint to test its strength, if low the joint slips and the friction enhancing agent is further activated and the strength of the joint rises up to a predetermined level, after which the torque is removed. These press fit joints are useful for joining small diameter tubes and are especially useful for making joins under water where the friction faces are prepared above water and protected by curing adhering layers as described hereinbefore that shear off during insertion in a way that prevents water reaching the prepared friction faces. Press fit joints are described with reference to illustrations as follows:

FIG. 10: shows in partial cross-section view the components for making an expandable joint between an end of a first tubular metal body (tmb) 201 and an end of a second tmb 202. This is referred to as a male-/female parallel overlap press fit joint. The method includes the following steps:
A. Preparing the area 203 on the outside of tmb 201 towards its end 204 by sizing and cleaning the surface of corrosion, dirt and mill-scale to leave the surface as a shinny metal, free of hydrocarbon residues. Area 203 is now referred to as the ‘first inner face’ 203 of the joint. Thus the first inner face 203 is adjacent to the end 204 of tmb 201. The diameter of tmb 202 is expanded 208 and a second inner face 205 is prepared adjacent to the end 206 of the second tmb 202, face 205 prepared leaving it clean and to size. First face 203 and second face 205 having natural oxide layers thereon. The diameter of face 203 being sized slightly larger than face 205, the difference in diameter being typically such that upon insertion of sized portion of tube 201 into expanded portion of tube 202 the materials in both tubes are subjected to elastic deformation from between 50 to 100% of their elastic range.
B. Forming a first circumferential groove 207 around the first inner face 203 of the first tmb 201, and a second circumferential groove 209 around the second outer face 205 of the second tmb 202, the first circumferential groove 207 and second circumferential groove 209 being positioned so as to mutually align when the ends of the first and second tmbs are fitted together in use. The depth of circumferential grooves 207 and 209 being less than half the uncompressed height of the seal 210.
C. Fitting/applying a compressible sealing element 210 around either in the first groove 207 or alternately in the second groove 209, groove 207 being preferred because it is visible and easier to fit.
D. Applying to the first inner face 203 of the first tmb 201 a band of friction enhancing composition of indicated by shaded area 211, that is shown above groove 207, thereby preventing the friction enhancing composition from reaching the groove 207 or the seal 210 during assembly; and/or alternately, if the seal 210 has been previously positioned in groove 209, on the second outer face 205 of the second tmb 202, a band of friction enhancing composition shown by unshaded area 212 may be placed above the groove 209 on face 205. The bands 211 and 212 are positioned to cover only part of the overlap areas to allow upon forcing the parts together the initial sliding of the parts to occur between clean untreated faces to form an initial low friction join, thereby to establish true parallel alignment an avoiding premature uneven asperity welding because premature welding may lead to cocking, buckling and failed joints. Then as the parts are forced further together friction treated areas 211 and/or 212 come into contact and friction rises rapidly to create said high friction joint. As tmb 201 is forced further into tmb 202 so the areas treated with the friction enhancing composition 211 and 212 continue in sliding contact with mating faces and the insertion forces required to maintain sliding rapidly rise. After fully inserting the joined parts 201 and 202 may be gripped and subjected to a further predetermined torsion and if they cannot withstand this force they slip (rotate) and the resultant rubbing further activates the friction enhancing composition and strengthens the joint, which ensures the frictional coupling within the press fit joint is fully developed.

FIG. 11: shows in partial cross-section view of a joint assembled from the components shown in FIG. 10 in the configuration of a male/female joint. In practice either areas 211 or 212 or both 211 and 212 may be treated, depending upon convenience, smoothness of the surfaces, cleanliness and quality of the interference fit. It is advisable to conduct separate trials to determine how much treatment is needed for a particular set of conditions beforehand because it may vary especially with surface roughness.

An alternative means of applying the friction enhancing composition during the assembly of the components shown in FIG. 10 is to assemble the joint by pressing the assembly together approximately half way dry, without treating areas 211 and 212 thereby form said low friction joint. At approximately half insertion the sliding is stopped and, providing the joint is oriented vertically as shown in FIG. 11, a metered measure of low viscosity friction enhancing composition is dispensed into the tapered recess 222 between 201 and 202 and time is allowed for the friction enhancing composition to run around the tapered recess and wet it thoroughly. Keeping the joint upright and upon resuming pressing in the fluid is drawn between the bodies within the natural roughness of faces 203 and 205 sufficient to cause the increase in sliding friction and thereby form said high friction join.

The high friction treated band within the joint is shown by the broken line within 220. The seal 221 also acts as a mechanical interlock because it is made of metal and expands into the space created by the alignment of first circumferential groove 207 and second groove 209 when assembled.

FIG. 12: shows in partial cross-section view a similar set of components to make an expandable joint that differs from FIG. 11 by employing a short length of separate slightly larger coupling tube 230 that slides over the ends 234 of tmb 231 and 236 of tmb 232, thereby forming two identical joints arranged back to back within the same coupling. This being a male tmb/female coupling-female coupling/male tmb configuration. The assembly procedure includes the following steps:
A. Forming a first outer face 233 adjacent to the end 234 of the first tmb 231, and a second outer face 235 adjacent the to the end 236 of the second tmb 232, the first 233 and second 235 faces having natural oxide layers thereon.
B. Forming an upset ring 237 on the outside surface tmb 231 positioned beyond the reach of the overlapping coupling tube after assembly and a similar second upset ring 238 on the outside surface of tmb 232 again positioned beyond the reach of the overlapping coupling tube after assembly. The purpose of these upset rings is twofold; first they provide means of gripping tmb 231 and tmb 232 to enable the tmbs to be pulled together without distorting the tmbs as the joint is assembled; second that during radial expansion the joint and tmb members axially shorten, whereas the upset rings 237 and 238 flatten out and axially extend to compensate for the aforementioned shortening.
C. Forming a tubular metal coupling member 230 having a third inner face 239 adjacent one end of the coupling member and a fourth inner face 240 adjacent the other end of the coupling member, the third 239 and fourth 240 faces having oxide layers thereon and being overlappable with the first 233 and second faces 235 of the first tmb 231 and second tmb 232 to enable the first tmb 231 and second tmb 232 to fit together with coupling member 230 in an interfering fit that when assembled causes the materials in the overlapping bodies to be elastically deformed to an extent from 50 to 100% of their elastic range.
D. Forming a first circumferential groove 241 around the first outer face 233 of the first tmb 231, a second circumferential groove 242 around the second outer face 235 of the second tmb 232, a third circumferential groove 243 around the third inner face 239, and a fourth circumferential groove 244 around the fourth inner face 240. The first circumferential grooves 241 and 243 being positioned so as to mutually align when the end of the first tmb 231 is inserted into the coupling member 230, the circumferential grooves 242 and 244 being positioned so as to mutually align when the end of the second tmb 232 is inserted into the coupling member 230.
E. Applying a first compressible sealing element 245 around the first 241 or third 243 circumferential grooves.
F. Applying a second compressible sealing element 246 around the second 242 or fourth 244 circumferential grooves.
G. Treating shaded areas the third face 248 and 250 on inner faces 239 and 240 of the coupling body 230 by depositing a friction enhancing composition on shaded regions as described herein before.
H. Inserting the first outer face 233 of the first tmb 231 about half way inside the third inner face 239 of the tubular metal coupling body 230 such that the first tmb 231 fits inside tubular metal coupling body 230 with initially low frictional contact between the first outer 233 face and the untreated portion of the third inner face 239, the level of friction rising to a second higher level between the two bodies during further sliding as the face 247 contacts treated area 248. Sliding stops when the first grove 241 and third grove 243 are aligned, and the compressible sealing element 245 occupies the first 241 and second 243 circumferential grooves.
I. Inserting the second outer face 235 of the second tmb 232 about half way inside the fourth inner face 240 of the tubular metal coupling body 230 such that the second tmb 232 fits inside tubular metal coupling body 230 with initially low frictional contact between the second outer face 235 and the untreated portion of the fourth inner face 240, the level of friction rising between the two bodies during sliding to a second higher level between the two bodies during further sliding as the face 249 contacts treated area 250. Sliding stops when the first grove 242 and third grove 244 are aligned, and the compressible sealing element 246 occupies the third 242 and second 244 circumferential grooves.
J. The depth of circumferential grooves 241, 242, 243, and 244 being less than half the uncompressed height of the seal 245 and 246.

FIG. 13: shows a partial cross-section view of the assembled joint made with the component parts illustrated in FIG. 12. This joint is configured as a male/female-female/male and is shown with only the female areas 248 and 250 treated with the friction enhancing agent, so that if the seals 245 and 246 had been assembled into either grooves 241 and 242 or 243 and 244 before assembly but after the application of the friction enhancing composition shown in shaded areas 248 and 250, then upon assembly the seals 252 and 253 will not come into contact with the friction enhancing composition during assembly. The outline of the trapped high friction contact bands are shown with broken lines 251 and 254 towards the centre of the joint. If the seals are positioned in grooves 243 and 244 coupling body 230 can be conveniently prepared remotely, which minimises the preparation required on the tmbs 231 and 232 at the assembly site.

FIG. 14: shows in partial cross-section view of an alternative back to back coupling arrangement that uses two joints made by the method described in FIGS. 10 and 11, and it uses a separate coupling tube 260 that fits inside a first tmb 261 and a second tmb 262. This joint differs from that illustrated in FIGS. 12 and 13 by the coupling tube 260 being positioned inside tmb 261 and 262 rather than outside. Thus this joint is configured as a female/male-male/female assembly. In essence the procedural steps for assembling the coupling illustrated in FIGS. 14 and 15 duplicate those for FIGS. 10 and 11 and therefore need not be repeated.

An advantage of this configuration is realised when clad or internally lined tmbs are joined. For example, if an alloy steel tube is clad with a corrosion resistant liner at 263 and 264 using for example stainless steel cladding, by using an internal coupling tube 260 made with similar stainless steel the joint is also made corrosion resistant, save for the grooves 265 and 266 that may have been machined through the stainless cladding to house the two seals 268 and 273. The preferred alternative is to form the seal grooves 268 and 273 by cold working (for example cold rolling) over the stainless clad layer that forms the extra projections 271 on the first tmb and 272 in on the second tmb, so that the corrosion resistance of first and second tmbs is preserved intact. Providing the seals 268 and 273 are also made of a corrosion resistant material such as stainless spring steel, the entire joint is made more corrosion resistant.

The friction enhancing compositions work equally well between stainless and regular steel. It is most preferably applied to the outer face of coupling 260 shown by the shaded area 267. Also if the seals are made of suitably hard materials and are pre-located in grooves 269 and 270 they act as scrapers during assembly to clean faces 275 and 276.

FIG. 15: shows in partial cross-section the joint assembled with the components shown in FIG. 14 in the alternative construction employing a short male coupling tube 260 secured within the ends of tmbs 278 and 279. The areas 277 within the broken lines define hidden the high friction areas.

### Examples of Joints

By way of an example proving joints are made between lengths of seamless cold drawn annealed fine grain hydraulic tubing 35 mm outside diameter (o/d) and 29 mm inside diameter (i/d) to E235 acc. to ENB 10305-4 (St.37.4 as per DIN 1630). The joints used smooth face to face seals. Referring now to FIG. 1 the method includes the following steps:
I. Preparing area 3 on the outside of tubular metal body 1 towards its end 4 by sizing to an o/d of 35 mm and cleaning the surface of corrosion and dirt to leave the surface as a shinny metal, dry and free of hydrocarbon residues and with a roughness of less than 5 μm Ra. The i/d of tubular metal body 2 was expanded at 8 to 35.5 mm and second face 5 prepared on the inner surface at a second end portion adjacent to the end 6 to a similar standard. There being a loose fit between the friction faces 3 and 5 to be joined of about 0.5 mm.
II. Applying to the first outer face 3 of the first tubular metal body 1 a band of friction enhancing agent of indicated by shaded area 11 in FIG. 1, applied wetting a small piece of green grade ScotchBright non-woven abrasive pad with Dow Corning DC1107 hydrogendimethylsiloxane. The joint is assembled by carefully aligning tubular metal body 1 onto the same axis as tubular metal body 2, and inserting 3 into 5 to position the friction faces within the overlap between tubular metal body 1. The area treated with the friction enhancing agent 11 is now aligned with untreated area 12. A 30 mm diameter swage tool was passed through both tubes to bring the friction faces into contact and form an initial low friction join. Tubes 1 and 2 were then gripped and a torque was applied across the join and the join slipped. The resultant rubbing caused the strength of the frictional resistance to rise from 165 Nm up to 512 Nm upon slipping about 312°, the increase in friction due to the activation of the entrapped friction enhancing agent by sliding (rubbing), the calculated strength of the tube being in the order of 550 Nm.
III. A second swage tool with a diameter of 37.5 mm was passed through the assembly to expand the joined tubes to internal diameters ranging from 37.4 mm at the leading edge of the inner tube 23 to 37.8 mm through the overlap section to 37.9 in the non overlapped section. This represents an enlargement of approximately 30% on diameter.
IV. After enlargement the pipe ends were sealed and the cavity filled with hydraulic oil and pressurised to 350 bar for 10 minutes without leakages or loss of pressure.

By way of an example the following data are relevant to the assembly of two typical joints made by the method disclosed in this invention. The tubes joined are L80 grade steel as defined by the API (American Petroleum Institute) specifications for Oil Country Tubular Goods:

Joint 1: Single overlap as illustrated in FIGS. 1 and 2.

| | | | |
|---|---|---|---|
| Dimensions: | joint inside- diameter | 91.6 | mm |
| | joint diameter | 101.6 | mm |
| | joint outside diameter | 111.6 | mm |
| | length of high friction sect. | 40 | mm |
| | interference at elastic limit | 0.215 | mm |
| | press-in force at .215 int. | 405 | kN |
| | press off force at .215 int | 399 | kN |
| | torsion strength at .215 | >10.99 | kN · m |

Joint 2 Single overlap as illustrated in FIGS. 1 and 2.

| | | | |
|---|---|---|---|
| Dimensions | joint inside diameter | 327.6 | mm |
| | joint diameter | 355.6 | mm |
| | joint outside diameter | 111.6 | mm |
| | length of high friction sect | 140 | mm |
| | interference at elastic limit | 0.76 | mm |
| | press-in force at 0.76int. | 4.5 | megN |
| | press off force at 0.76int | 4.4 | megN |
| | torsion strength at 0.76int | >385 | kN · m |

It will be understood that the present invention has been described above by way of example only and that the above description can be modified in many different ways without departing from the scope of the invention as defined by the appended claims.

All publications, patents, and patent applications cited herein, and any US patent family equivalent to any such patent or patent application, are hereby incorporated herein by reference to their entirety to the same extent as if each publication, patent, or patent application was specifically and individually indicated to be incorporated by reference.

1. A method of forming a high friction joint between a first tubular metal body and a second tubular metal body, the method comprising:
I. selecting a first tubular metal body having a first outer face at a first end portion thereof and selecting a second tubular body having a second inner face at a second end portion thereof, said first and second faces being capable of overlap to enable the first and second tmbs to fit together;
II. treating the first outer face of the first tubular metal body and/or the second inner face of the second tubular metal body by introducing a friction enhancing agent to at least part of one or both thereof;
III. inserting the first end portion of the first tubular metal body inside the second end portion of the second tubular metal body such as to form a low friction joint therebetween; and
IV. moving the first end portion of the first tubular body relative to the second end portion of the second tubular body to create rubbing at the first and second faces to activate the friction enhancing agent and to thereby form said high friction joint.

2. A method as claimed in claim 1, wherein moving the first end portion of the first tubular body relative to the second end portion is by relative axial movement thereof.

3-7. (canceled)

8. A method of forming a joint between a first tubular metal body and a second tubular metal body, the method comprising:
I. selecting a first tubular metal body having a first outer face at a first end portion thereof and selecting a second tubular body having a second outer face at a second end portion thereof;
II. selecting a tubular metal coupling member having a third inner face at a third end portion of the coupling member and a fourth inner face at a fourth end portion of the coupling member, the third and fourth faces being capable of overlap with the first and second faces of the first and second tmbs to enable the first and second tmbs to fit together with the coupling member;
III. treating the first outer face of the first tubular metal body, and/or the third inner face of the tubular metal coupling body by introducing a friction enhancing agent to at least part of one or both thereof;
IV. treating the second outer face of the second tubular metal body, and/or the fourth inner face of the tubular metal coupling body by introducing a friction enhancing agent to at least part of one or both thereof;
V. inserting the first end portion of the first tubular metal body inside the third end portion of the tubular metal coupling body such as to form a low friction joint therebetween;
VI. inserting the second end portion of the second tubular metal body inside the fourth end portion of the tubular metal coupling body such as to form a low friction joint therebetween;
VII. moving the first end portion of the first tubular body relative to the third end portion of the tubular metal coupling body to create rubbing at the first and third faces to activate the friction enhancing agent and to thereby form a high friction joint therebetween; and
VIII. moving the second end portion of the second tubular body relative to the fourth end portion of the tubular metal coupling body to create rubbing at the second and fourth faces to activate the friction enhancing agent and to thereby form a high friction joint therebetween.

9. A method as claimed in claim 8, wherein moving the first end portion of the first tubular body relative to the third end portion of the tubular metal coupling body or moving the second end portion of the first tubular body relative to the fourth end portion of the tubular metal coupling body is by relative axial movement thereof.

10-14. (canceled)

15. A method of forming a joint between a first tubular metal body and a second tubular metal body, the method comprising:
I. selecting a first tubular metal body having a first inner face at a first end portion thereof and selecting a second tubular body having a second inner face at a second end portion thereof;
II. selecting a tubular metal coupling member having a third outer face at a third end portion of the coupling member and a fourth outer face at a fourth end portion of the coupling member, the third and fourth faces being capable of overlap with the first and second faces of the first and second tmbs to enable the first and second tmbs to fit together with the coupling member;
III. treating the first inner face of the first tubular metal body, and/or the third outer face of the tubular metal coupling body by introducing a friction enhancing agent to at least part of one or both thereof;
IV. treating the second inner face of the second tubular metal body, and/or the fourth outer face of the tubular metal coupling body by introducing a friction enhancing agent to at least part of one or both thereof;
V. inserting the third end portion of the tubular metal coupling body inside the first end portion of the first tubular metal body such as to form a low friction joint therebetween;
VI. inserting the fourth end portion of the tubular metal coupling body inside the second end portion of the second tubular metal body such as to form a low friction joint therebetween;
VII. moving the first end portion of the first tubular body relative to the third end portion of the tubular metal coupling body to activate the friction enhancing agent and to thereby form a high friction joint therebetween; and
VIII. moving the second end portion of the second tubular body relative to the fourth end portion of the tubular metal coupling body to activate the friction enhancing agent and to thereby form a high friction joint therebetween

16. A method as claimed in claim 15, wherein moving the first end portion of the first tubular body relative to the third end portion of the tubular metal coupling body or moving the second end portion of the first tubular body relative to the fourth end portion of the tubular metal coupling body is by relative axial movement thereof.

17-59. (canceled)

60. A method of forming a high friction joint between an end of a first tubular metal body and an end of a second tubular metal body, the method comprising:
I. forming a first inner face adjacent to the end of the first tubular metal body, and a second outer face on an expanded length adjacent the to the end of the second tubular body, the first and second faces having natural oxide layers thereon and being overlapable to enable the ends of the first and second tmbs to fit together in use;
II. forming a first circumferential groove around the first inner face of the first tubular metal body, and a second circumferential groove around the second outer face of the second tubular metal body, the first and second circumferential grooves being positioned so as to mutually align when the ends of the first and second tmbs are fitted together in use;
III. applying a compressible sealing element around the first or second circumferential grooves;
IV. treating of the first inner face of the first tubular metal body, and/or the second outer face of the second tubular metal body, by depositing a friction enhancing composition onto at least part of one or both of the said layers or incorporating a friction enhancing composition into part of one or both of the said oxide layers;
V. inserting the first inner face of the first tubular metal body inside the second outer face of the second tubular metal body such that the first and second tmbs fit together with frictional contact between the first inner face and the second outer face, and as sliding proceeds the level of sliding friction rises, the first and second circumferential grooves align, and the compressible sealing element occupies both the first and second circumferential grooves.

61. A method of forming a joint between an end of a first tubular metal body and an end of a second tubular metal body, the method comprising:
I. forming a first out face adjacent to the end of the first tubular metal body, and a second outer face adjacent the to the end of the second tubular body, the first and second faces having natural oxide layers thereon;
II. forming a tubular metal coupling member having a third inner face adjacent one end of the coupling member and a fourth inner face adjacent the other end of the coupling member, the third and fourth faces having oxide layers thereon and being overlapable with the first and second faces of the first and second tmbs to enable the first and second tmbs to fit together with the coupling member in use;
III. forming a first circumferential groove around the first outer face of the first tubular metal body, a second circumferential groove around the second outer face of the second tubular metal body, a third circumferential groove around the third inner face of the circumference, and a fourth circumferential groove around the fourth inner face of the circumference, the first and third circumferential grooves being positioned so as to mutually align when the end of the first tubular metal body is inserted into the coupling member, the second and fourth circumferential grooves being positioned so as to mutually align when the end of the second tubular metal body is inserted into the coupling member,
IV. applying a first compressible sealing element around the first or third circumferential groove;
V. applying a second compressible sealing element around the second or fourth circumferential groove;
VI. treating the first outer face of the first tubular metal body, and/or the third inner face of the tubular metal coupling body, by depositing a friction enhancing composition onto at least part of one or both of the said layers or incorporating a friction enhancing composition into at least part of one or both of the said oxide layers;
VII. treating the second outer face of the second tubular metal body, and/or the fourth inner face of the tubular metal coupling body, by depositing a friction enhancing composition onto at least part of one or both of the said layers or incorporating a friction enhancing composition into at least part of one or both of the said oxide layers;
VIII. inserting the first outer face of the first tubular metal body inside the third inner face of the tubular metal coupling body such that the first tubular metal body fits inside the tubular metal coupling body with frictional contact between the first outer face and the third inner face, the level of friction rising between the two sliding bodies, the first and third circumferential grooves align, and the compressible sealing element occupies both the first and second circumferential grooves.
IX. inserting the second outer face of the second tubular metal body inside the fourth inner face of the tubular metal coupling body such that the second tubular metal body fits inside the tubular metal coupling body with frictional contact between the second outer face and the fourth inner face, the level of friction rising between the two sliding bodies, the second and fourth circumferential grooves align, and the compressible sealing element occupies both the first and second circumferential grooves.
